(19) United States
(12) Patent Application Publication
(10) Pub. No.: US 2018/0367457 A1
(43) Pub. Date: Dec. 20, 2018

(54) COMMUNICATION CONTROL APPARATUS AND COMMUNICATION CONTROL METHOD

(71) Applicant: FUJITSU LIMITED, Kawasaki-shi (JP)

(72) Inventors: Yu Minakuchi, Yokohama (JP); Hideyuki Matsuda, Kanagawa (JP)

(73) Assignee: FUJITSU LIMITED, Kawasaki-shi (JP)

(21) Appl. No.: 16/005,179

(22) Filed: Jun. 11, 2018

(30) Foreign Application Priority Data
Jun. 16, 2017 (JP) 2017-118434

(51) Int. Cl. H04L 12/803; H04L 12/801

(52) U.S. Cl. CPC H04L 47/122; H04L 47/11

(57) ABSTRACT

There is provided a communication control apparatus including a memory, and a processor coupled to the memory and the processor configured to receive load information of each of a plurality of switches, when a first condition of a plurality of conditions related to a route is satisfied with the load information, receive a request for route information of a packet transmitted from a first switch of the plurality of switches, and inform the first switch of an instruction for outputting the packet to the route on which the first condition is satisfied.

### CROSS-REFERENCE TO RELATED APPLICATION

This application is based upon and claims the benefit of priority of the prior Japanese Patent Application No. 2017-118434, filed on Jun. 16, 2017, the entire contents of which are incorporated herein by reference.

### FIELD

The embodiments discussed herein are related to a communication control apparatus and a communication control method.

### BACKGROUND

In a software defined network (SDN), for example, one controller performs a route control among a plurality of switches by separating a transfer function and a control function. In the SDN, a control protocol called OpenFlow is used as a communication protocol between the switch and the controller. Hereinafter, a controller that executes the OpenFlow is referred to as an OF controller or an OFC. A switch that executes the OpenFlow is referred to as an OF switch or an OFS.

The OF switch is provided with a flow table including route information of the packets as an entry and transfers the packets according to the flow table. The OF controller performs a route control, for example, by setting the flow table of each OF switch. The route information of a packet is, for example, any one or a combination of an output port of the packet, and information of a transfer destination to which the packet is transferred next.

When the OF switch receives a packet that does not have the entry in the flow table, the OF switch uses a PacketIn message to inquire the OF controller about the entry of the flow table concerning the received packet. For example, the PacketIn message includes a packet body of an inquiry target.

As a response to the PacketIn message, the OF controller sends a FlowMod message instructing setting of the entry of the flow table to the OF switch of an inquiry source. Alternatively, the OF controller transmits a PacketOut message, which is an output instruction from a designated port of a packet to be inquired, to the OF switch of the inquiry source. The PacketOut message includes the packet included in the PacketIn message.

Hereinafter, messages of the OpenFlow such as the PacketIn message, the FlowMod message, and the PacketOut message are simply referred to as PacketIn, FlowMod, and PacketOut, respectively.

The PacketIn described above and the FlowMod or the PacketOut which is the response thereto may also be used for changing the route of a flow. Further, the flow is, for example, the flow of a packet having the same identification information.

For example, the route change of the flow using the PacketIn and the FlowMod is as follows. First, the OF controller sets the flow table of the OF switch so that the OF switch transfers the packet of the flow, which is the target of the route change, to the OF controller using the PacketIn. The FlowMod is used to set the flow table to the OF switch.

When the OF controller receives the PacketIn including the packet of the flow which is the target of the route change from the OF switch, the OF controller transfers the FlowMod to the OF switch. The FlowMod transmitted to the OF switch includes the entry of the flow table instructing to transfer the flow which is the target of the route change to a separate route. By receiving the FlowMod, the OF switch rewrites the flow table and transfers the flow as the target of the route change to a separate route designated as the FlowMod. As a result, the route of the flow as the target of the route change is changed.

Meanwhile, for example, the route change of the flow using the PacketIn and PacketOut is as follows. The OF controller sets the flow table of the OF switch by using the FlowMod so as to transfer the packet of the flow as the target of the route change to the OF controller by using PacketIn. The OF controller transmits the PacketOut specifying a port connected to the separate route as the output port of the packet to the PacketIn including the packet of the flow as the target of the route change.

By receiving the PacketOut, the OF switch outputs the packet of the flow as the target of the route change included in the PacketOut from the port connected to the specified separate route. As a result, the route of the flow as the target of the route change is changed.

For example, the route change using the PacketOut is smaller in the number of rewriting times of the flow table than the method using the FlowMod. Since it takes time to rewrite the flow table, when a faster route change is desired, the route change using the PacketOut may be adopted.

Related techniques are disclosed in, for example, Japanese Laid-Open Patent Publication No. 2013-118699.

### SUMMARY

According to an aspect of the invention, a communication control apparatus includes a memory, and a processor coupled to the memory and the processor configured to receive load information of each of a plurality of switches, when a first condition of a plurality of conditions related to a route is satisfied with the load information, receive a request for route information of a packet transmitted from a first switch of the plurality of switches, and inform the first switch of an instruction for outputting the packet to the route on which the first condition is satisfied.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system configuration of a communication system according to a first embodiment;

FIG. 2 is a diagram illustrating an example of communication between a video distribution server and a terminal;

FIG. 3 is a diagram illustrating an example of a part of a format of a load information packet;

FIG. 4 illustrates an example of a part of the format of a communication packet;

FIG. 5 is a diagram illustrating an example of a hardware configuration of a controller;

FIG. 6 is a diagram illustrating an example of a functional configuration of the controller;

FIG. 7 illustrates an example of a load information management table;

FIG. 8 illustrates an example of a topology information table;

FIG. 9 illustrates an example of a distribution determination table;

FIG. 10 illustrates an example of a flow management table;

FIG. 11A illustrates an example of a flowchart of processing of a transfer control unit;

FIG. 11B illustrates an example of the flowchart of the processing of the transfer control unit;

FIG. 12 illustrates an example of a flow table of switches #1, #2, #4, and #5 in an initial state of a communication system according to a specific example;

FIG. 13 illustrates an example of the flow table of switch #3 in the initial state of the communication system according to the specific example;

FIG. 14 is a diagram illustrating an example of routes of flow A and flow B when route #1 as a priority route starts to get congested;

FIG. 15 illustrates an example of the flow management table of the controller after processing illustrated in FIG. 14;

FIG. 16 illustrates an example of the flow table of switch #1 after the processing illustrated in FIG. 14;

FIG. 17 is a diagram illustrating an example of the routes of flow A and flow B when route #1 further gets congested after FIG. 14;

FIG. 18 illustrates an example of the flow management table of the controller after the processing illustrated in FIG. 17;

FIG. 19 illustrates an example of the flow table of switch #1 after the processing illustrated in FIG. 17;

FIG. 20 is a diagram illustrating an example of the routes of flow A and flow B when a traffic amount input into the terminal increases after FIG. 17;

FIG. 21 illustrates an example of the flow management table of the controller after the processing illustrated in FIG. 20; and

FIG. 22 is a diagram illustrating an example of the routes of flow A and flow B when the traffic amount input into the terminal decreases after FIG. 20.

### DESCRIPTION OF EMBODIMENTS

In a route change using the PacketOut, all packets of a flow as a target of the route change are transferred to an OF controller by the PacketIn. The transfer processing of the packets transferred to the OF controller by the PacketIn is performed by a central processing unit (CPU) of the OF controller. As a result, the load of the CPU of the OF controller increases and a transfer delay of another flow processed by the CPU of the OF controller may also increase in addition to the flow as the target of the route change.

Hereinafter, an embodiment of a technique for reducing the load of the CPU relating to the transfer processing of the packet will be described with reference to the accompanying drawings. A configuration of the following embodiment is an example and the present disclosure is not limited to the configuration of the embodiment.

### First Embodiment

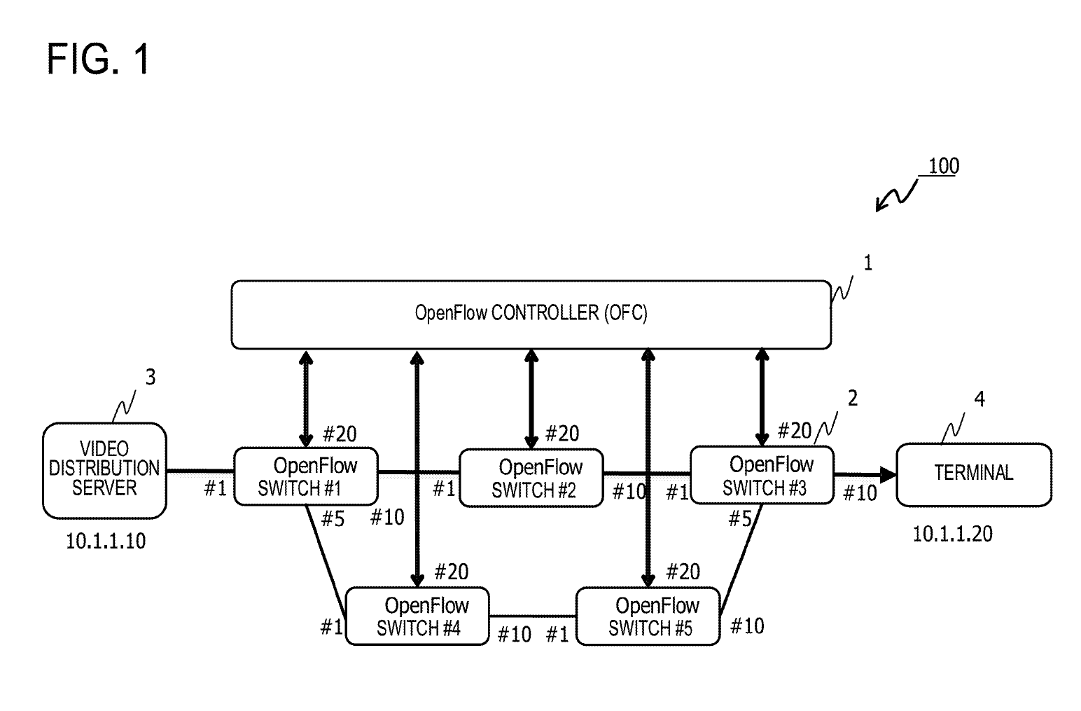

FIG. 1 is a diagram illustrating an example of a system configuration of a communication system 100 according to a first embodiment. The communication system 100 is, for example, a network of SDN. The communication system 100 includes, for example, OF switches #1 to #5, an OF controller 1 that controls the OF switch, a video distribution server 3, and a terminal 4. When OF switches #1 to #5 are not distinguished from each other, OF switches #1 to #5 are denoted as an OF switch 2. Hereinafter, the OF controller 1 and the OF switch 2 are referred to as a controller 1 and a switch 2, respectively. The OF controller 1 is an example of a “communication control apparatus”. The OF switch 2 is an example of an “each of a plurality of switches”.

In the communication system 100, the network to which the controller 1 and the switch 2 are connected and the network to which the switch 2, the video distribution server 3, and the terminal 4 are connected are physically or logically separated from each other. A network through which a control signal between the controller 1 and the switch 2 flows is called a control plane. A network through which a user signal relayed between the switches 2 flows is called a data plane. In FIG. 1, the communication of the control plane is indicated by a double line, and the communication of the data plane is indicated by a single line. The OF messages including, for example, the PacketIn, the PacketOut, and the FlowMod flow through the control plane.

The video distribution server 3 holds video contents and transmits target video contents to the terminal 4 according to a request from the terminal 4.

FIG. 1 also illustrates an example of a connection relationship between the controller 1 and each switch 2 and allocation of Internet protocol (IP) addresses of the video distribution server 3 and the terminal 4. Hereinafter, the connection relationship of the communication system 100 and the allocation of the IP address are based on the connection relationship and the allocation illustrated in FIG. 1.

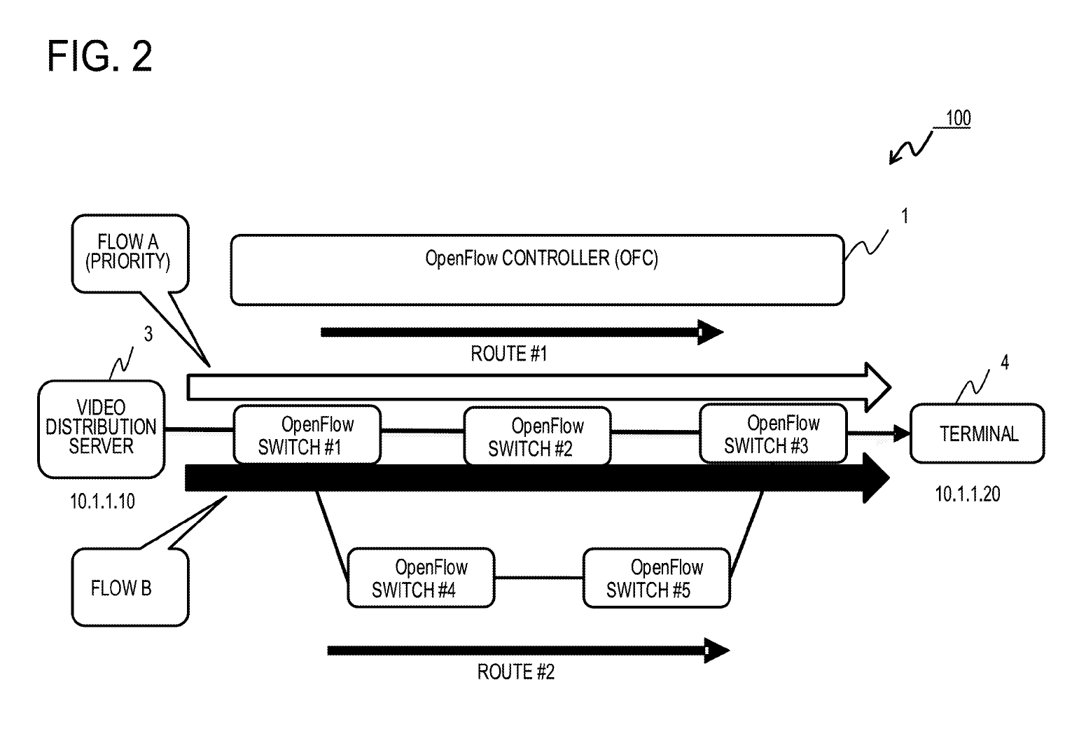

FIG. 2 is a diagram illustrating an example of communication between a video distribution server 3 and a terminal 4. In FIG. 2, the communication of the control plane is omitted for simplicity. It is assumed that two types of flows, for example, flow A and flow B flow between the video distribution server 3 and the terminal 4. Both flow A and flow B are flows in which a transmission source is the video distribution server 3 and a reception destination is the terminal 4.

The flow is, for example, a collection of packets identified by the same identification information flowing in the communication system 100. For example, at least a reception destination and transmission source IP addresses, and a reception destination and transmission source port numbers are used as flow identification information for identifying the flow, and a protocol type and predetermined information in a header are used as an option.

Flow A is, for example, a flow in which low delay such as streaming of sound data, video data, or sound data or moving picture data is desired. In the meantime, flow B is a flow that allows delay, such as downloading the sound data, the video data, or the like. Therefore, in the first embodiment, a priority is set higher for flow A than for flow B.

There are two routes, that is, route #1 that passes through switch #1, switch #2, and switch #3 in that order and route #2 that passes through switch #1, switch #4, switch #5, and switch #3 in that order from the video distribution server 3 to the terminal 4. For example, since the number of switches through which route #1 passes is smaller than the number of switches through which route #2 passes, route #1 has a smaller transfer delay. Therefore, in the first embodiment, route #1 is used as a priority route. Route #2 is used as a detour route. In an initial state, each switch 2 is set so that flow A and flow B pass through route #1 which is the priority route.

In the first embodiment, the controller 1 receives load information from each switch 2 at a predetermined period. The load information is, for example, information indicating a processing load of each switch 2. Based on the load information, the controller 1 monitors a congestion degree of route #1 which is the priority route. When route #1 starts to get congested, the controller 1 performs control so that the route of flow B with a low priority is changed from route #1 as the priority route to route #2 as the detour route.

In the first embodiment, the controller 1 performs the route change using the PacketOut. Specifically, when the traffic amount of route #1 as the priority route reaches a predetermined value, the controller 1 sets the transfer of the packet of flow B by the PacketIn to the controller 1 in the flow table of switch #1. The flow table is set using, for example, the FlowMod. The switch #1 becomes a setting target of the flow table because the switch #1 is the switch 2 located at a branch point between route #1 and route #2.

Next, when the controller 1 receives the PacketIn including the packet of flow B from switch #1, the controller 1 transmits the PacketOut including the designation of the port connected to route #2 to switch #1 as the output port of the packet. As a result, the route of flow B is changed from route #1 to route #2.

In the first embodiment, the controller 1 includes a programmable logic device (PLD) in addition to the CPU. In the first embodiment, the controller 1 causes the PLD of the controller 1 to execute a process of responding to the PacketIn including the packet of flow B from switch #1 with the PacketOut. As a result, the processing load of the CPU due to the processing of the PacketIn may be reduced.

In addition, although the processing by the CPU is software processing, the processing by the PLD is hardware processing, and as a result, the processing speed of the PLD is faster than that of the CPU. By processing the PacketIn related to flow B by the PLD, the transfer delay of flow B transferred using route #2 may be suppressed to be smaller. Hereinafter, the processing of the controller 1 which responds to the PacketIn from the switch 2 with the PacketOut instructing the output to the detour route and transfers the packet is simply referred to as packet transfer processing.

PacketIn is an example of “a request for route information of a packet”. Since the PacketIn is a message used for inquiring about the entry of the flow table, the entry of the flow table is an example of “route information of a packet”. The PacketOut is an example of “an instruction for outputting”. The FlowMod that sets the flow table of the switch 2 so as to transfer the packet of the flow as the target of the route change to the controller 1 using the PacketIn is an example of “transfer instruction of a request for packet route information”. The packet transfer processing is an example of “inform the first switch of an instruction for outputting the packet to the route on which the first condition is satisfied”.

### Packet Used in Communication System

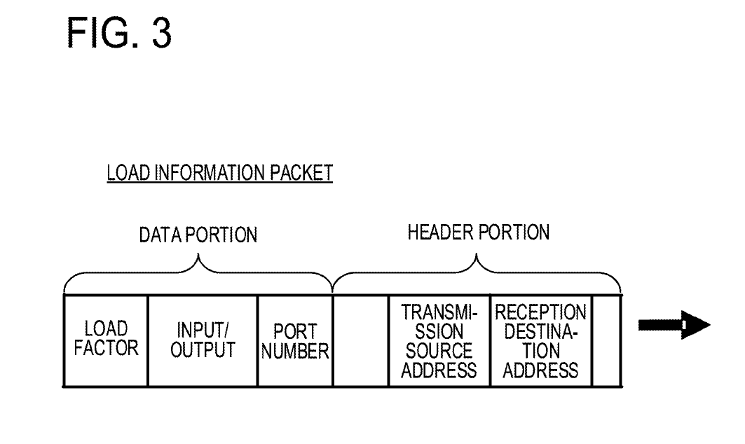

FIG. 3 is a diagram illustrating an example of a part of the format of a load information packet. The load information packet is a packet used for transmitting load information from the switch 2 to the controller 1. Therefore, the load information packet is a packet flowing in the control plane. The switch 2 transfers the load information packet to the controller 1 at a predetermined period. A transfer period of the load information packet is arbitrarily set by an administrator of the communication system 100, for example, within 1 second to several tens of seconds.

In FIG. 3, a part of the format of the load information packet, which is related to the first embodiment, is extracted and illustrated. The load information packet includes fields of a reception destination address and a transmission source address in a header portion. In the field of the reception destination address, the IP address of the controller 1 is set. In the field of the transmission source address, the IP address of the switch 2 is set.

Further, the load information packet includes fields of a port number, input/output, and a load factor in a data portion. In the field of the port number, an identification number of a target port among the ports of the switch 2 is stored.

In the field of the input/output, information indicating whether the information stored in the field of the load factor is information on the input of the target port or information on the output is stored. For example, the information indicating whether the information stored in the field of the load factor is the information on the input of the target port or the information on the output, which is stored in the input/output field is a flag.

For example, when the flag is “0”, it is indicated that the information stored in the load factor field is the information on the input of the target port. For example, when the flag is “1”, it is indicated that the information stored in the load factor field is the information on the input of the target port.

In the load factor field, for example, the packet flow rate in an input or output direction of the target port is stored. Hereinafter, the packet flow rate in the input direction of the port is referred to as an input flow rate. The packet flow rate in the output direction of the port is referred to as an output flow rate.

In the data portion of the load information packet, for example, a combination of the fields of the port number, the input/output, and the load factor is included for the inputs and outputs of all ports held by the switch 2. However, the present disclosure is not limited thereto. For example, the switch 2 may create the load information packet including the information on the input and output for each of all ports held by the switch 2, and transfer the load information packet to the controller 1.

Further, the information transmitted by the load information packet is not limited to the input or output flow rate of the port. For example, information such as a usage rate of the CPU of the switch 2 may be transmitted by the load information packet.

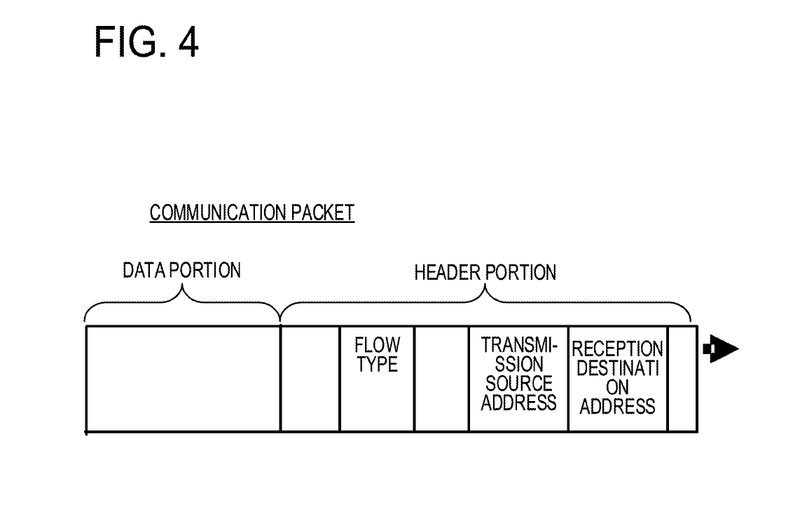

FIG. 4 illustrates an example of a part of the format of a communication packet. The communication packet is a packet used for transfer of user data and is a packet relayed by each switch 2. Therefore, the communication packet is a packet flowing in the data plane. In FIG. 4, a part of the format of the communication packet, which is related to the first embodiment, is extracted and illustrated.

The header portion of the communication packet includes a field storing information indicating the reception destination address, the transmission source address, and a flow type. For example, when the reception destination is the terminal 4, “10.1.1.20” which is the IP address of the terminal 4 is stored in the field of the reception destination address. For example, when the transmission source is the video distribution server 3, “10.1.1.10” which is the IP address of the video distribution server 3 is stored in the field of the transmission source address.

The field storing the information indicating the flow type indicates a field for storing information used as flow identification information except for the reception destination address and the transmission source address. For example, when reception destination and transmission source port numbers are used as the flow identification information in addition to the reception destination and transmission source IP addresses, the fields of the reception destination port number and the transmission source port number correspond to the field storing the information indicating the flow type.

### Apparatus Configuration

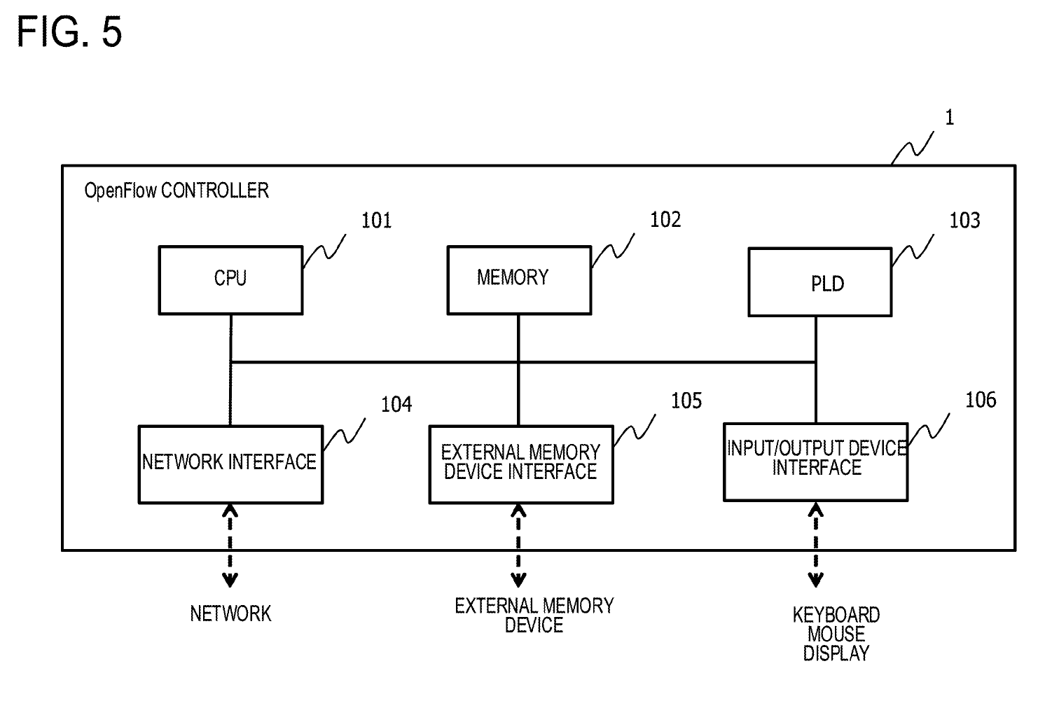

FIG. 5 is a diagram illustrating an example of a hardware configuration of a controller 1. The controller 1 is, for example, a dedicated or universal computer. The controller 1 includes a CPU 101, a memory 102, a PLD 103, a network interface 104, an external memory device interface 105, and an input/output device interface 106. The CPU 101, the memory 102, the PLD 103, the network interface 104, the external memory device interface 105, and the input/output device interface 106 are electrically connected by a bus.

The memory 102 is a memory device used as a main memory device. The memory 102 includes, for example, a random access memory (RAM) and a read only memory (ROM). The RAM is a semiconductor memory such as, for example, a dynamic RAM (DRAM), a static RAM (SRAM), or a synchronous DRAM (SDRAM). The memory 102 provides a work area for loading a program stored in the ROM or the external memory device to the CPU 101 or is used as a buffer.

The external memory device interface 105 is an interface with the external memory device. The external memory device is, for example, a nonvolatile memory. The nonvolatile memory is, for example, an erasable programmable ROM (EPROM), or a hard disk drive. The external memory device stores, for example, an operating system (OS), a program for the OF controller, a processing distribution program, and other application programs.

The program for the OF controller is a program for causing a computer to operate as the controller of the OpenFlow. The processing distribution program is a program for causing the PLD 103 to execute the packet transfer processing. Further, the external memory device may be mounted inside the controller 1.

The PLD 103 is an electronic component including electronic circuits including an I/O module, a logic circuit, a wiring resource, and a memory. The PLD 103 as a programmable logic circuit executes programmed logic. Specifically, the PLD 103 may execute predetermined processing logic by writing the connection relationship between the I/O module and the logic circuit by the wiring resource in the memory. Writing the connection relationship between the I/O module and the logic circuit by the wiring resource in the memory of the PLD 103 is referred to as, for example, a configuration. The logic indicates, for example, an order, a method, or contents of processing.

The configuration of the PLD 103 may be changed, for example, while the controller 1 is in operation. Further, the configuration of the PLD 103 is changed, for example, by executing a program for changing the configuration of the PLD by the CPU 101. The program for changing the configuration of the PLD is stored, for example, in the external memory device. The PLD 103 may be a field programmable gate array (FPGA) or a non-programmable logic circuit such as an application specific integrated circuit (ASIC).

The CPU 101 executes various processing by loading the OS or the program stored in the external memory device to the memory 102 and executing the OS or the program. A plurality of CPUs 101 may be used. The CPU 101 is an example of a “processor”.

The network interface 104 is, for example, a circuit and a port for connecting a cable of a wired network line such as an optical cable or a local area network (LAN) cable.

The input/output device interface 106 is an interface of an input device or an output device. The input device is, for example, a pointing device such as a keyboard or a mouse. The output device is, for example, a display or a printer.

Further, the hardware configuration of the controller 1 illustrated in FIG. 5 is an example, and the configuration is not limited to the above, and omission, substitution, and addition of constituent elements may be made as appropriate according to the embodiment. For example, the controller 1 may include a processor such as a digital signal processor (DSP) or a network processor in addition to the CPU 101.

The switch 2 is, for example, the dedicated or universal computer. The switch 2 includes the CPU, the memory, the network interface, the input/output interface, and the like as the hardware configuration. Regarding each hardware component, an outline is similar to that of the controller 1 and a description thereof will be omitted. The switch 2 stores the program for an OpenFlow switch and a load information transmission program in the memory. The program for the OpenFlow switch is a program for executing processing as an OpenFlow switch defined by the OpenFlow. The load information transmission program is a program for transmitting the load information to the controller 1 at a predetermined period.

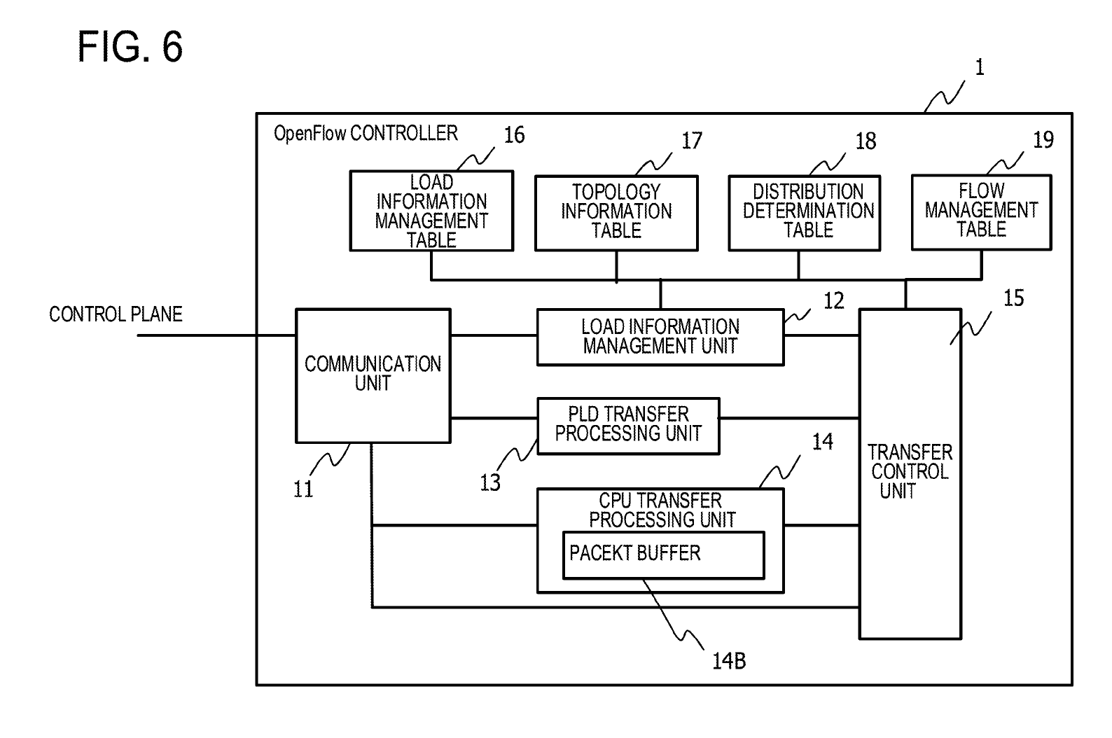

FIG. 6 is a diagram illustrating an example of a functional configuration of the controller 1. The controller 1 includes, as functional components, a communication unit 11, a load information management unit 12, a PLD transfer processing unit 13, a CPU transfer processing unit 14, a transfer control unit 15, a load information management table 16, a topology information table 17, a distribution determination table 18, and a flow management table 19.

The communication unit 11 is, for example, one of the functional components achieved using the network interface 104 by executing the OS by the CPU 101 of the controller 1. The network to which the communication unit 11 is connected is the control plane and the communication unit 11 inputs/outputs the packet which flows in the control plane.

The communication unit 11 outputs the packet input from the network to a predetermined functional component. Specifically, when the load information packet (see, e.g., FIG. 3) is input, the communication unit 11 outputs the load information packet to the load information management unit 12. For example, when PacketIn is input, the communication unit 11 outputs PacketIn to the PLD transfer processing unit 13 or the CPU transfer processing unit 14 according to the instruction from the transfer control unit 15. Further, the communication unit 11 outputs, for example, the packets input from the PLD transfer processing unit 13 and the CPU transfer processing unit 14 to the network.

The PLD transfer processing unit 13 is achieved by executing a program for changing the configuration of the PLD 103 by the PLD 103 and the CPU 101. In the first embodiment, the PLD transfer processing unit 13 executes the packet transfer processing on a designated flow according to the instruction from the transfer control unit 15. When the PLD transfer processing unit 13 performs the packet transfer processing, the PacketIn is input from the communication unit 11 into the PLD transfer processing unit 13 and the PacketOut is output from the PLD transfer processing unit 13 to the communication unit 11.

The CPU transfer processing unit 14 is a functional component achieved by executing the program for the OF controller by the CPU 101 of the controller 1. The CPU transfer processing unit 14 receives the input of the packet from the communication unit 11. The CPU transfer processing unit 14 performs processing as the OpenFlow controller according to the input packet.

The CPU transfer processing unit 14 includes a packet buffer 14B. The packet buffer 14B is created, for example, in a part of the memory area of the memory 102. When the PacketIn for the flow designated by the transfer control unit 15 is input, the CPU transfer processing unit 14 extracts the packet body of the flow from the PacketIn and stores the extracted packet in the packet buffer 14B. The packet stored in the packet buffer 14B is read from the packet buffer 14B by the CPU transfer processing unit 14 according to the instruction from the transfer control unit 15 and included in the PacketOut and transmitted to the predetermined switch 2.

Further, the CPU transfer processing unit 14 also creates the FlowMod according to the instruction from the transfer control unit 15 and transmits the created FlowMod to the designated switch 2 from the transfer control unit 15.

Each of the load information management unit 12, the transfer control unit 15, the load information management table 16, the topology information table 17, the distribution determination table 18, and the flow management table 19 is, for example, one of functional components achieved by executing the processing distribution program by the CPU 101 of the controller 1.

The load information management unit 12 receives the input of the load information packet from the communication unit 11. The load information management unit 12 updates the load information management table 16 (to be described later) with the contents of the input load information packet.

The transfer control unit 15 detects the flow as the target of the route change based on the load information management table 16 and the distribution determination table 18 (to be described later). The transfer control unit 15 instructs the CPU transfer processing unit 14 to perform the setting for transferring the packet of the flow as the target of the route change to the controller 1 using the PacketIn in the corresponding switch 2.

Further, the transfer control unit 15 determines, on the basis of the distribution determination table 18, which of the PLD transfer processing unit 13 and the CPU transfer processing unit 14 performs the packet transfer processing for the flow as the target of the route change and instructs the PLD transfer processing unit 13 or the CPU transfer processing unit 14 to perform the packet transfer processing of the flow as the target of the route change. Details of the processing of the transfer control unit 15 will be described later.

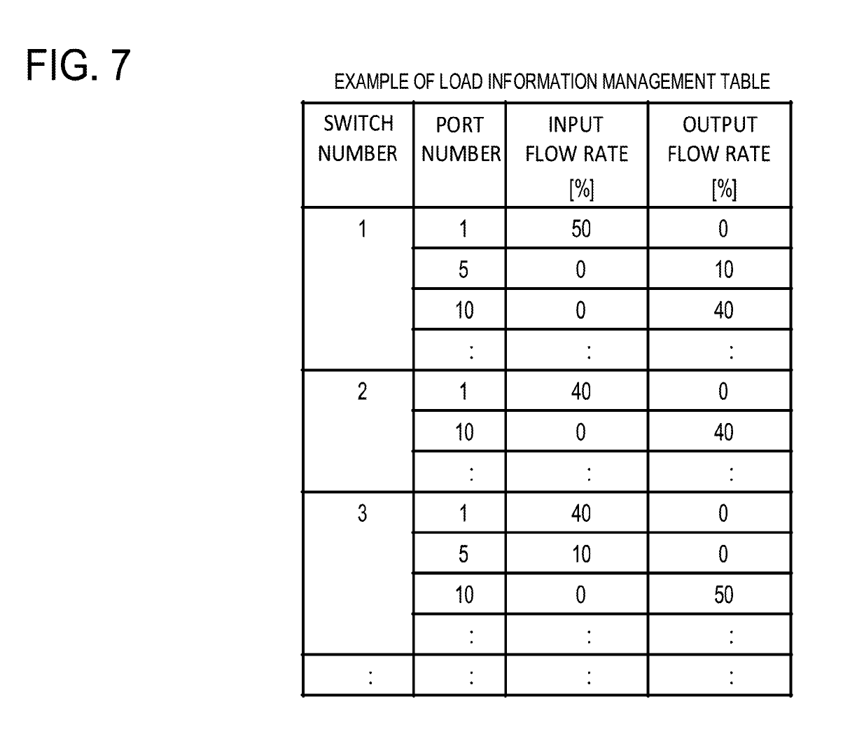

FIG. 7 illustrates an example of a load information management table 16. The load information management table 16 is a table for holding the load information transmitted from each switch 2 at a predetermined period. The load information management table 16 is held, for example, in the memory 102 of the controller 1. FIG. 7 illustrates the load information management table 16 when the load information packet has the format illustrated in FIG. 3.

In the entry of the load information management table 16, for example, the switch number, the port number, the input flow rate, and the output flow rate are stored. The input flow rate or the output flow rate is a ratio of an input amount or an output amount of the packet to a maximum transfer band of the port expressed in percentage.

The load information management table 16 is updated by the load information management unit 12 each time the load information packet arrives from each switch 2.

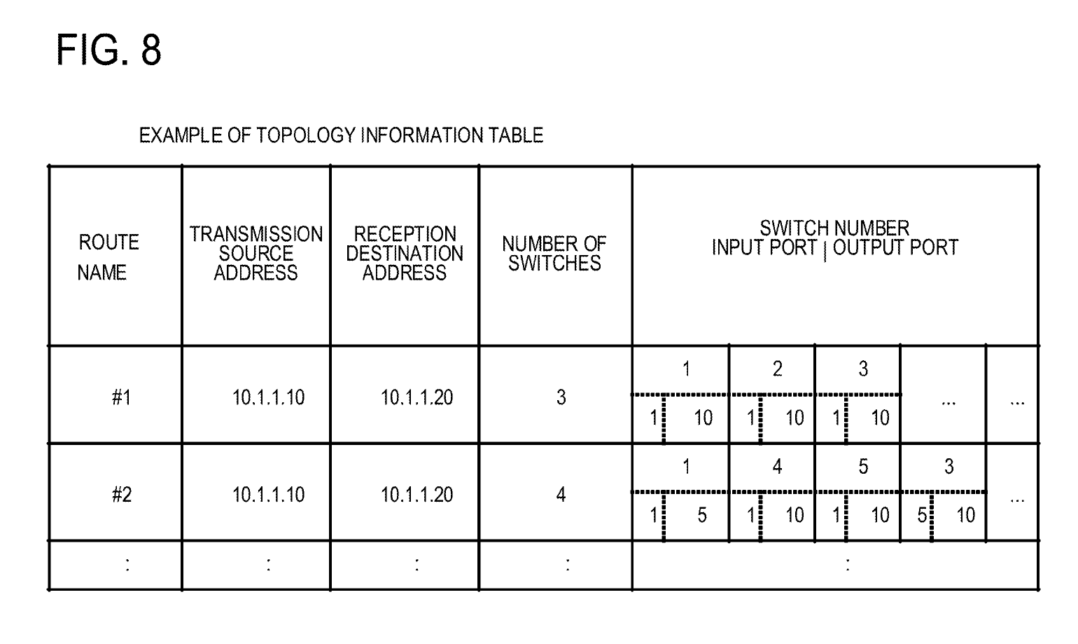

FIG. 8 illustrates an example of a topology information table 17. The topology information table 17 holds information on the route existing between the transmission source and the reception destination for each combination of the transmission source and the reception destination within the communication system 100. The topology information table 17 is held in the memory 102, for example, by the administrator of the communication system 100 in advance. In FIG. 8, information on two routes existing between the video distribution server 3 as the transmission source and the terminal 4 as the reception destination (see, e.g., FIG. 2) is illustrated.

In the entry of the topology information table 17, for example, a route name, a communication source address, the reception destination address, the number of switches, and the switch number are stored. The number of switches stored in the entry of the topology information table 17 is the number of switches 2 on the route. In the first embodiment, a route with the smallest number of switches 2 to be passed through is used as the priority route and the remaining routes are used as the detour route. In the example illustrated in FIG. 8, since the number of switches of route #1 is 3 and the number of switches of route #2 is 4, route #1 is the priority route and route #2 is the detour route. However, the priority of the route is not limited to the priority based on the number of switches 2 to be passed through.

The numbers of the switches stored in the entry of the topology information table 17 is the identification number of each switch 2 on the route. In the entry of the topology information table 17, the identification numbers of the input port and the output port of each switch 2 on the route are stored together with the switch number. The switch numbers stored in the entry of the topology information table 17 are stored in the order of the pass-through.

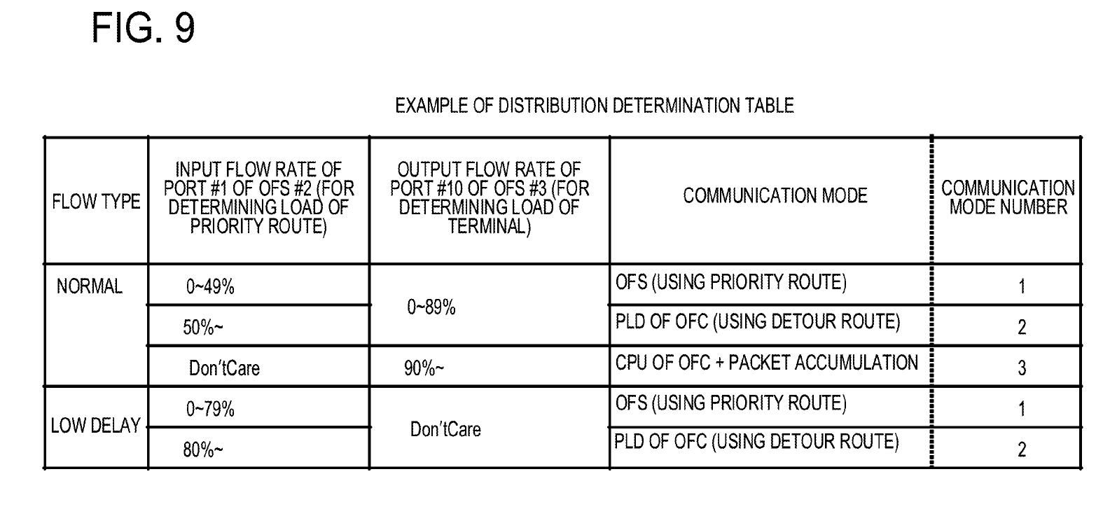

FIG. 9 illustrates an example of a distribution determination table 18. The distribution determination table 18 holds an association between a processing distribution rule for the packet and a communication mode for each type of flow flowing in the communication system 100. FIG. 9 illustrates the processing distribution rule for the packet for each flow type with respect to flows having the video distribution server 3 as the transmission source and the terminal 4 as the reception destination.

In the example illustrated in FIG. 9, two flow types including “normal” and “low delay” are illustrated. The flow of the flow type “low delay” is a flow having a higher priority than the flow of the flow type “normal”. Whether the flow type is “normal” or “low delay” is determined by a value of the field storing information indicating the flow type in the communication packet. A classification of the flows of “normal” and “low delay” is set, for example, by the administrator of the communication system 100 in advance.

In the example illustrated in FIG. 9, the input flow rate of port #1 of switch #2 and the output flow rate of port #10 of switch #3 are used as the processing distribution rule for the packet. The input flow rate of port #1 of switch #2 is used as one measure of measuring the congestion degree of route #1 which is the priority route between the video distribution server 3 and the terminal 4. The congestion degree of the route may be rephrased as, for example, a flooding degree of the route.

However, a factor used as a measure of measuring the congestion degree of route #1 which is the priority route is not limited to the input flow rate of port #1 of switch #2. For example, the input flow rate or the output flow rate of the port of the switch 2 existing in a portion of route #1 which is not in common with route #2 may be used as the measure for measuring the congestion degree of route #1. Further, a combination of the input flow rate or the output flow rate of a plurality of ports of the switch 2 existing in the portion of route #1 which is not in common with route #2 may be used as the measure for measuring the congestion state of route #1.

The output flow rate of port #10 of switch #3 is used as one of the measures for measuring the traffic amount input into the terminal 4. However, a factor used as the measure for measuring the traffic amount input into the terminal 4 is not limited to the output flow rate of port #10 of switch #3.

In the example illustrated in FIG. 9, three types of communication modes are defined as the communication mode. Each communication mode is identified by the identification number. In the communication mode of communication mode number “1”, the priority route is used for transfer of the flow. In the communication mode of communication mode number “1”, the packet is transferred by the transfer of the switch 2 without going through the controller 1. In an initial state, any flow has the communication mode of communication mode number “1”.

In the communication mode of communication mode number “2”, the detour route is used for transfer of the flow. In the communication mode of communication mode number “2”, the packet of the flow is transferred to the controller 1 by PacketIn to cause the PLD transfer processing unit 13 to execute the packet transfer processing for the flow.

In the communication mode with communication mode number “3”, the packet of the flow is buffered by the controller 1.

In the example illustrated in FIG. 9, when the input flow rate of port #1 of switch #2 is 0 to 49% and the output flow rate of port #10 of switch #3 is 0 to 89%, it is defined that the flow of the flow type “normal” becomes the communication mode of communication mode number “1”. When the input flow rate of port #1 of switch #2 is 50% or more and the output flow rate of port #10 of switch #3 is 0 to 89%, it is defined that the flow of the flow type “normal” becomes the communication mode of communication mode number “2”. When the output flow rate of port #10 of switch #3 is 90%, it is defined that the flow of the flow type “normal” becomes the communication mode of communication mode number “3”.

When the input flow rate of port #1 of switch #2 is 0 to 79%, it is defined that the flow of the flow type “low delay” becomes the communication mode of communication mode number “1”. When the input flow rate of port #1 of switch #2 is 80% or more, it is defined that the flow of the flow type “low delay” becomes the communication mode of communication mode number “2”.

In the distribution determination table 18 illustrated in FIG. 9, it is indicated that when route #1 as the priority route starts to get congested, the route is changed from the flow of flow type “normal” having the low priority to route #2 which is the detour route. For example, it is determined that when the input flow rate of port #1 of switch #2 is 50% or more, route #1 as the priority route starts to get congested. This suppresses an increase in the transfer delay of the flow of flow type “low delay” having a higher priority.

Further, the priority route and the detour route are determined, for example, for each combination of the transmission source and the reception destination. Therefore, as the measure for measuring the congestion degree of the priority route and the measure for measuring the traffic amount input into the reception destination, which port of which switch 2 the load information is used in is appropriately determined for each combination of the transmission source and the reception destination.

The priority route is an example of a “first route”. The detour route is an example of a “second route” and a “route on which the first condition is satisfied”. A condition relating to the measure for measuring the congestion degree of the priority route is an example of the “first condition” and a condition “related to traffic congestion of the first route”. A condition relating to the measure for measuring the traffic amount input into the reception destination is an example of a “second condition relating to processing load of a destination of the first route”.

More specifically, the processing distribution rule of the packet, “the input flow rate of port #1 of switch #2 is 50% or more” for flow type “normal” in the distribution determination table 18 illustrated in FIG. 9 is an example of the “first condition”. Further, the processing distribution rule of the packet, “the input flow rate of port #1 of switch #2 is 80% or more” for flow type “low delay” in the distribution determination table 18 illustrated in FIG. 9 is another example of the “first condition”. The processing distribution rule of the packet, “the output flow rate of port #10 of switch #3 is 90% or more” in the distribution determination table 18 illustrated in FIG. 9 is an example of the “second condition relating to processing load of a destination of the first route”. The communication mode of communication mode number “2” is an example of the “information of the route on which the first condition is satisfied”.

Further, the distribution determination table 18 illustrated in FIG. 9 is an example. The communication mode may be determined, for example, based on any one of the condition for the measure for measuring the congestion degree of the priority route and the condition for the measure for measuring the traffic amount input into the reception destination. For example, when the input flow rate of port #1 of switch #2 is 50% or more, the controller 1 may determine to change the communication mode of the corresponding flow to communication mode number “2” regardless of the output flow rate of port #10 of switch #3.

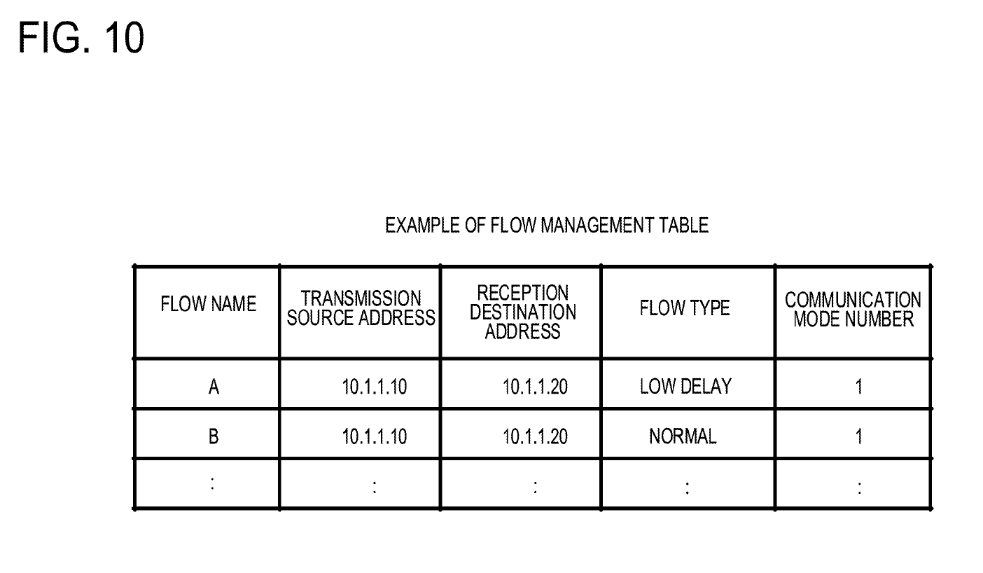

FIG. 10 illustrates an example of a flow management table 19. The flow management table 19 holds information on the flow flowing in the communication system 100. The flow management table 19 is stored, for example, in the memory 102.

In the entry of the flow management table 19, a flow name, the transmission source address, the reception destination address, the flow type, and the communication mode number are stored. For example, any one of “normal” and “low delay” is stored in the flow type of the entry of the flow management table 19. The communication mode number of the communication mode applied to the flow is stored in the communication mode number of the entry of the flow management table 19.

In the entry of the flow management table 19, the flow name, the transmission source address, the reception destination address, and the flow type are input in advance, for example, by the administrator of the communication system 100. The communication mode number of the entry of the flow management table 19 is updated by the transfer control unit 15 each time the communication mode is changed.

The load information management table 16, the topology information table 17, the distribution determination table 18, and the flow management table 19 are not limited to the examples illustrated in FIGS. 7 to 10, respectively.

### Flow of Processing

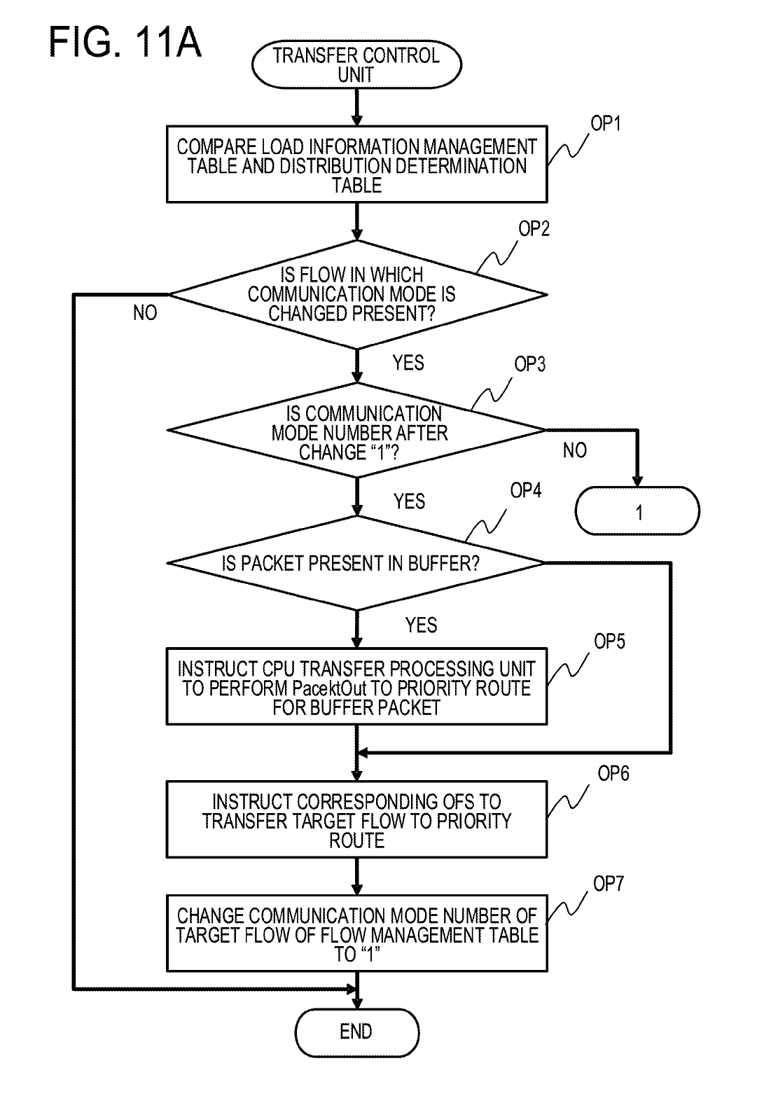

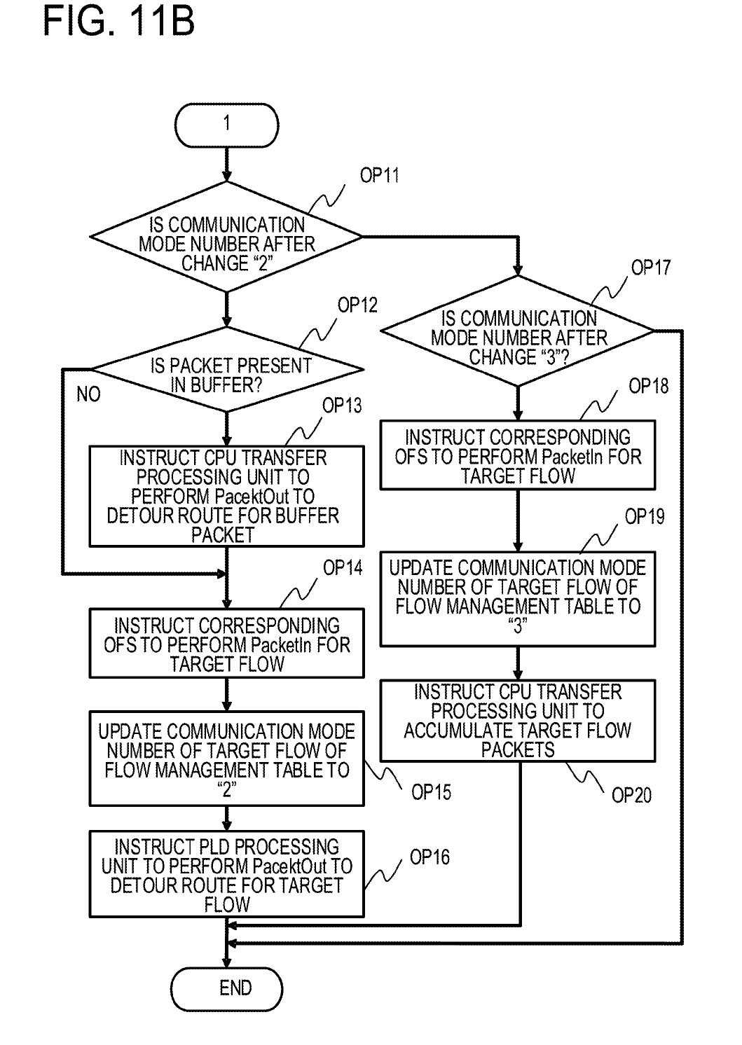

FIGS. 11A and 11B illustrate an example of a flowchart of processing of the transfer control unit 15. The processing illustrated in FIGS. 11A and 11B is executed at a predetermined period. The execution period of the processing illustrated in FIGS. 11A and 11B is arbitrarily set by the administrator of the communication system 100, for example, between 10 milliseconds and 1 second. The execution period of the processing illustrated in FIGS. 11A and 11B may be the same as, for example, the transmission period of the load information packet of the switch 2.

The processing illustrated in FIGS. 11A and 11B is processing on the premise of the communication mode defined in the distribution determination table 18 illustrated in FIG. 9. An execution subject of the processing illustrated in FIGS. 11A and 11B is the CPU 101 of the controller 1, but for the sake of convenience, the transfer control unit 15 which is the functional component achieved by executing the processing distribution program by the CPU 101 is described as a subject.

In OP1, the transfer control unit 15 compares the load information management table 16 and the distribution determination table 18 to determine the communication mode of each flow. In OP2, the transfer control unit 15 determines whether there is the flow in which the communication mode is changed as a result of comparing the load information management table 16 and the distribution determination table 18. In the first embodiment, a current communication mode of the flow flowing in the communication system 100 is held in the flow management table 19 (see, e.g., FIG. 10).

When there is the flow in which the communication mode is changed (OP2: YES), the processing proceeds to OP3. When there is no flow in which the communication mode is changed (OP2: NO), the processing illustrated in FIG. 11A ends.

In OP3, the transfer control unit 15 determines whether the communication mode number after the change of the flow in which the communication mode is changed is “1”. Hereinafter, the flow in which the communication mode is changed will be referred to as a target flow. When the communication mode number after the change of the target flow is “1” (OP3: YES), the processing proceeds to OP4. When the communication mode number after the change of the target flow is not “1” (OP3: NO), the processing proceeds to OP11 of FIG. 11B.

The processing from OP4 to OP7 is processing when the communication mode number after the change of the target flow is “1”. In OP4, the transfer control unit 15 determines whether the packets of the target flow are accumulated in the packet buffer 14B. The reason is that when the communication mode number before the change of the target flow is “3”, the packets of the target flow are accumulated in the packet buffer 14B.

When the packets of the target flow are accumulated in the packet buffer 14B (OP4: YES), the processing proceeds to OP5. When the packets of the target flow are not accumulated in the packet buffer 14B (OP4: NO), the processing proceeds to OP6.

In OP5, the transfer control unit 15 instructs the CPU transfer processing unit 14 to output PacketOut designating the port connected to the priority route as the output port of the packet of the target flow in the packet buffer 14B to the corresponding switch 2. As a result, the CPU transfer processing unit 14 generates the PacketOut that designates the port connected to the priority route as the output port of the packet of the target flow in the packet buffer 14B and outputs the generated PacketOut to the corresponding switch 2.

The switch 2 corresponding to a transmission destination of the PacketOut is the switch 2 of a transmission source of the PacketIn including the packets accumulated in the packet buffer 14B. Further, the PacketOut generated by the CPU transfer processing unit 14 includes, for example, the packet of the target flow accumulated in the packet buffer 14B and a designation of the port of the corresponding switch 2 connected to the priority route as the output port of the packet. Which port of the corresponding switch 2 is connected to the priority route is acquired by referring to the topology information table 17.

In OP6, the transfer control unit 15 instructs the CPU transfer processing unit 14 to transmit the setting of transferring the packet of the target flow to the priority route to the corresponding switch 2. Upon receiving the instruction from the transfer control unit 15, the CPU transfer processing unit 14 transmits the FlowMod for setting the transfer of the packet of the target flow to the priority route in the flow table of the corresponding switch 2 to the corresponding switch 2. As a result, the flow table of the corresponding switch 2 is rewritten and the corresponding switch 2 transfers the packet of the target flow to the priority route.

The corresponding switch 2 in OP6 is, for example, the switch 2 located at the branch point between the priority route and the detour route. The FlowMod transmitted to the corresponding switch 2 includes, for example, flow identification information of the target flow and the designation of the port of the corresponding switch 2 connected to the priority route as the output port. The switch 2 located at the branch point between the priority route and the detour route and which port of the corresponding switch 2 is connected to the priority route are acquired by referring to the topology information table 17.

In OP7, the transfer control unit 15 updates the communication mode number of the entry of the target flow in the flow management table 19 to “1”. Thereafter, the processing illustrated in FIG. 11A ends.

The processing illustrated in FIG. 11B is processing when the communication mode number after the change of the target flow is “2” or “3”. In OP11, the transfer control unit 15 determines whether the communication mode number after the change of the target flow is “2”. When the communication mode number after the change of the target flow is “2” (OP11: YES), the processing proceeds to OP12. When the communication mode number after the change of the target flow is not “2” (OP11: NO), the processing proceeds to OP17.

The processing from OP12 to OP16 is processing when the communication mode number after the change of the target flow is “2”. In OP12, the transfer control unit 15 determines whether the packets of the target flow are accumulated in the packet buffer 14B.

When the packets of the target flow are accumulated in the packet buffer 14B (OP12: YES), the processing proceeds to OP13. When the packets of the target flow are not accumulated in the packet buffer 14B (OP12: NO), the processing proceeds to OP14.

In OP13, the transfer control unit 15 instructs the CPU transfer processing unit 14 to output the PacketOut designating the port connected to the detour route as the output port of the packet of the target flow in the packet buffer 14B to the corresponding switch 2. As a result, the CPU transfer processing unit 14 generates the PacketOut that designates the port connected to the detour route as the output port of the packet of the target flow in the packet buffer 14B and outputs the generated PacketOut to the corresponding switch 2. The processing of OP13 is the same as the processing of OP5.

In OP14, the transfer control unit 15 instructs the PLD transfer processing unit 13 to transmit the setting of transferring the packet of the target flow using PacketIn to the controller 1 to the corresponding switch 2. Upon receiving the instruction from the transfer control unit 15, the PLD transfer processing unit 13 transmits the FlowMod for setting the transfer of the packet of the target flow to the controller 1 using the PacketIn in the flow table of the corresponding switch 2 to the corresponding switch 2. As a result, upon receiving the packet of the target flow, the corresponding switch 2 includes the packet in the PacketIn and transfers the PacketIn including the packet to the controller 1.

The corresponding switch 2 is, for example, the switch 2 located at the branch point between the priority route and the detour route. The FlowMod transmitted to the corresponding switch 2 includes, for example, the flow identification information of the target flow and the designation of the port of the corresponding switch 2 connected to the controller 1 as the transmission instruction or the output port of PacketIn.

In OP15, the transfer control unit 15 updates the communication mode number of the entry of the target flow in the flow management table 19 to “2”.

In OP16, the transfer control unit 15 instructs the PLD transfer processing unit 13 to execute the packet transfer processing for the target flow. Specifically, the transfer control unit 15 instructs the PLD transfer processing unit 13 to output the PacketOut designating the port connected to the detour route as the output port with respect to the input of the PacketIn for the target flow. For example, the flow identification information of the target flow and the port number connected to the detour route of the switch 2 of the transmission destination of the PacketOut are input into the PLD transfer processing unit 13 together with the instruction. Upon receiving the instruction from the transfer control unit 15, the PLD transfer processing unit 13 changes the configuration of the PLD 103.

Further, the transfer control unit 15 instructs the communication unit 11 to output the PacketIn of the target flow to the PLD transfer processing unit 13. Thereafter, the processing illustrated in FIG. 11B ends.

In OP17, the transfer control unit 15 determines whether the communication mode number after the change of the target flow is “3”. When the communication mode number after the change of the target flow is “3” (OP17: YES), the processing proceeds to OP18. When the communication mode number after the change of the target flow is not “3” (OP17: NO), the processing illustrated in FIG. 11B ends.

The processing from OP18 to OP20 is processing when the communication mode number after the change of the target flow is “3”.

In OP18, the transfer control unit 15 instructs the PLD transfer processing unit 13 to transmit the setting of transferring the packet of the target flow using the PacketIn to the controller 1 to the corresponding switch 2. The corresponding switch 2 is, for example, the switch 2 located at the branch point between the priority route and the detour route. The processing of OP18 is the same as the processing of OP14.

In OP19, the transfer control unit 15 updates the communication mode number of the entry of the target flow in the flow management table 19 to “3”.

In OP20, the transfer control unit 15 instructs the CPU transfer processing unit 14 to accumulate the packets included in the PacketIn in the packet buffer 14B with respect to the input of the PacketIn including the packet of the target flow. Further, the transfer control unit 15 instructs the communication unit 11 to output the PacketIn of the target flow to the CPU transfer processing unit 14. Thereafter, the processing illustrated in FIG. 11B ends.

In addition, in the OP2 of FIG. 11A, when there is a plurality of flows of which communication modes are changed, the transfer control unit 15 repeatedly performs the processing after OP3 in FIG. 11A and the processing illustrated in FIG. 11B for each flow of which communication mode is changed.

In the processing illustrated in FIGS. 11A and 11B, the processing related to the output of the packets accumulated in the packet buffer 14B (OP4, OP5, OP12, and OP13) and the processing related to the change of the communication mode (OP6, OP7, and OP14 to OP16) are executed as a series of processing. However, the present disclosure is not limited thereto and the processing related to the output of the packets accumulated in the packet buffer 14B and the processing related to the change of the communication mode may be executed at different momentums. For example, the processing related to the output of packets accumulated in the packet buffer 14B of OP1 to OP5 and OP11 to OP13 may be executed at a predetermined period. For example, the processing relating to the change of the communication mode in OP1 to OP3, OP6 to OP7, OP11, OP14 to OP16, and OP17 to OP20 may be executed upon the arrival of the PacketIn from the switch 2.

### Specific Example

As a specific example, a case will be described in which the routes of flow A and flow B from the video distribution server 3 to the terminal 4 in the communication system 100 illustrated in FIG. 1 are changed. Flow A has a higher priority than flow B and is the flow of flow type “low delay”. Flow B is the flow of flow type “normal”.

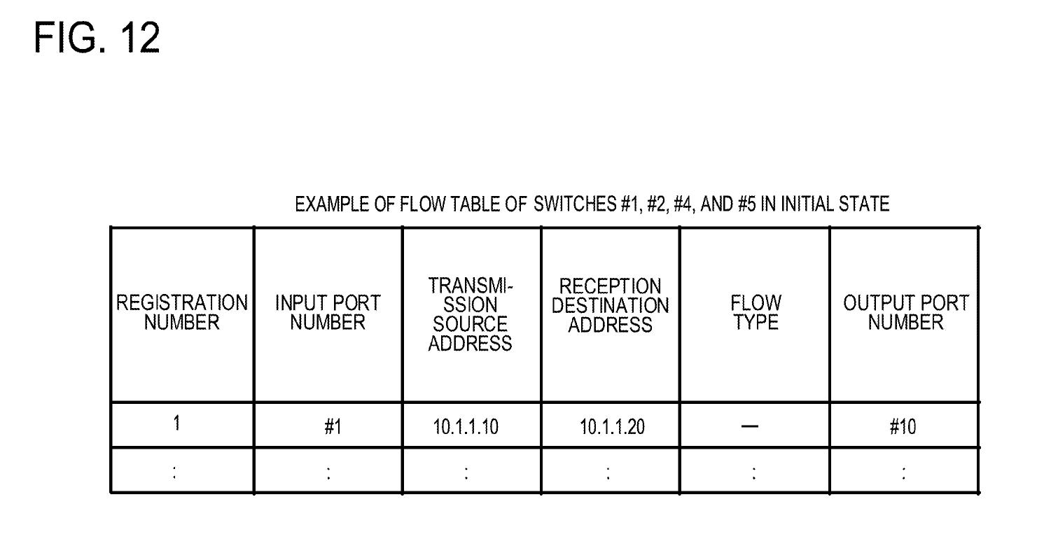

FIG. 12 illustrates an example of a flow table of switches #1, #2, #4, and #5 in an initial state of a communication system 100 according to a specific example. When the packets of the transmission source address of 10.1.1.10 and the reception destination address of 10.1.1.20 are input from port #1, the entry of registration number “1” indicating that the packet is output from port #10 is stored in the flow table illustrated in FIG. 12 (see, e.g., FIG. 1).

When the flow table illustrated in FIG. 12 is the flow table of switch #1 located at the branch point between route #1 and route #2 (see, e.g., FIG. 2), it is indicated that the entry with registration number “1” transfers the corresponding packet to route #1. This is because port #10 of switch #1 which is the output port is the port connected to route #1. That is, it is indicated that in the initial state, the packet is transferred to route #1 which is the priority route together with flow A and flow B.

When the flow table illustrated in FIG. 12 is the flow table of switch #2, it is indicated that the entry with registration number “1” transfers the corresponding packet to route #1. This is because port #10 of switch #2, which is the output port, is the port connected to route #1.

When the flow table illustrated in FIG. 12 is the flow table of switch #4 and switch #5, it is indicated that the entry with registration number “1” transfers the corresponding packet to route #2. This is because port #10 of switch #4 and switch #5, which is the output port, is the port connected to route #2.

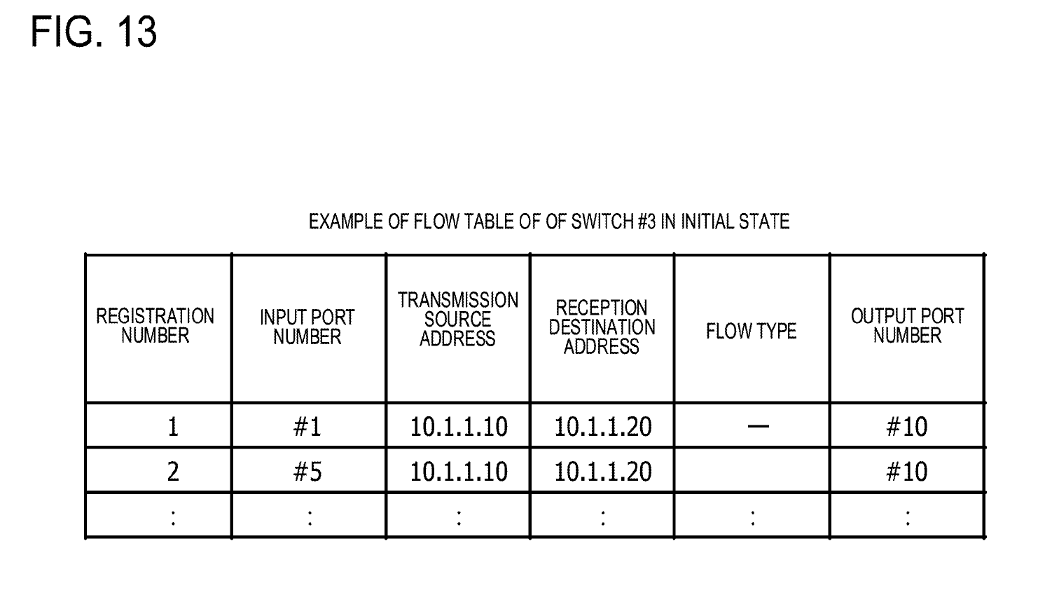

FIG. 13 illustrates an example of the flow table of switch #3 in the initial state of the communication system 100 according to the specific example. When the packets of the transmission source address of 10.1.1.10 and the reception destination address of 10.1.1.20 are input from port #1, the entry of registration number “1” indicating that the packet is output from port #10 is stored in the flow table illustrated in FIG. 13 (see, e.g., FIG. 1). When the packets of the transmission source address of 10.1.1.10 and the reception destination address of 10.1.1.20 are input from port #5, the entry of registration number “2” indicating that the packet is output from port #10 is stored in the flow table illustrated in FIG. 13 (see, e.g., FIG. 1).

Switch #3 is located at a joining point of route #1 and route #2 (see, e.g., FIG. 2). Therefore, the entry of registration number “1” for transferring the packet input from route #1 and the entry of registration number “2” for transferring the packet input from route #2 are stored in the flow table of switch #3 illustrated in FIG. 13.

Therefore, from FIGS. 12 and 13, it is illustrated that route #1 and route #2 are set in each switch 2 in the initial state of the communication system 100.

In the specific example, the flow management table 19 of the controller 1 in the initial state is as illustrated in FIG. 10.

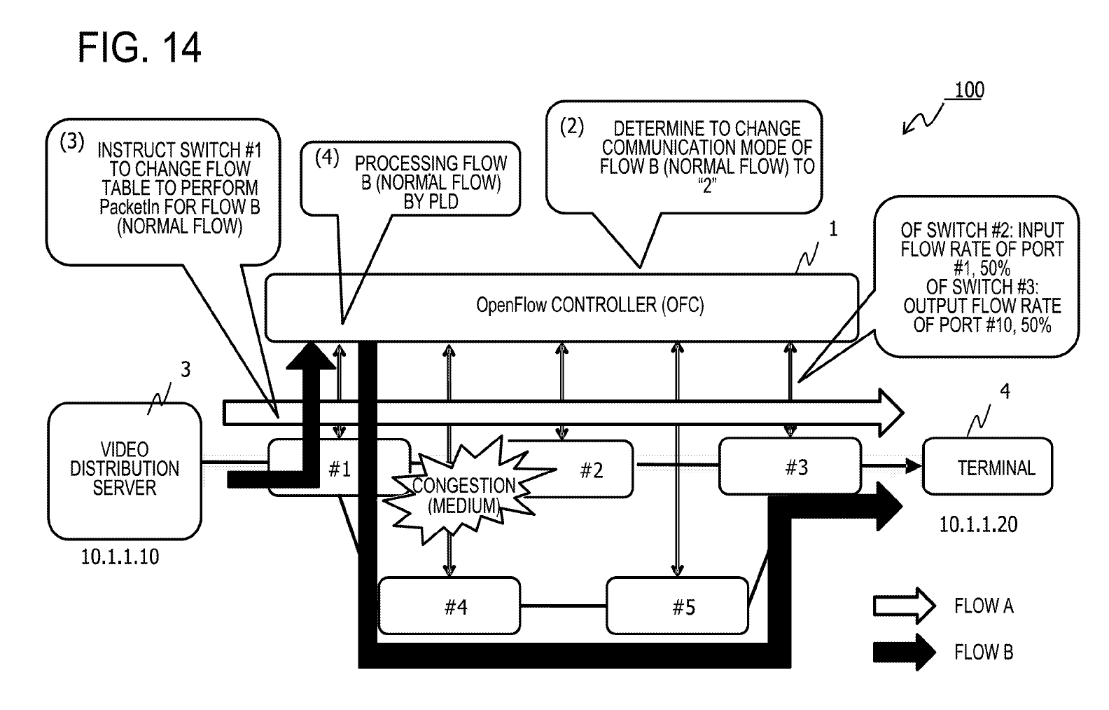

FIG. 14 is a diagram illustrating an example of routes of flow A and flow B when route #1 as a priority route starts to get congested. (1) The controller 1 receives load information including that the input flow rate of port #1 of switch #2 is 50% from switch #2. The load information from switch #2 indicates that route #1 which is the priority route starts to get congested. Further, the controller 1 transmits load information including that the output flow rate of port #10 of switch #3 is 50% from switch #3 to the controller 1. The contents of the load information are reflected to the load information management table 16.

(2) Based on the load information management table 16 and the distribution determination table 18, the controller 1 determines to change the communication mode of flow B, which is flow type “normal”, to the communication mode of communication mode number “2” (OP11: YES in FIG. 11B). That is, the controller 1 determines to cause the PLD transfer processing unit 13 to execute the packet transfer processing for flow B.

(3) The controller 1 sets transferring the packet of flow B to the controller 1 using the PacketIn in the flow table of switch #1 (OP14 in FIG. 11B). Switch #1 is the switch 2 located at the branch point between route #1 and route #2.

As a result, switch #1 transfers the packet of flow A to route #1 and the packet of flow B to the controller 1 by the PacketIn.

(4) The controller 1 sets the PLD transfer processing unit 13 so as to transmit the PacketOut designating the port connected to route #2 to switch #1 as the output port of the packet of flow B (OP16 in FIG. 11B). When the packet of flow B is transferred from switch #1 to the controller 1 by the PacketIn, the PLD transfer processing unit 13 of the controller 1 transmits the PacketOut designating the port connected to route #2, for example, as the output port of the packet of flow B to switch #1.

The PacketOut transmitted from the PLD transfer processing unit 13 includes, for example, the packet of flow B transferred to the controller 1 by the PacketIn and the designation of port #5 of switch #1 as the output port.

Upon receiving the PacketOut, switch #1 outputs the packet of flow B included in the PacketOut from port #5 connected to route #2. As a result, the route of flow B is changed from route #1 to route #2.

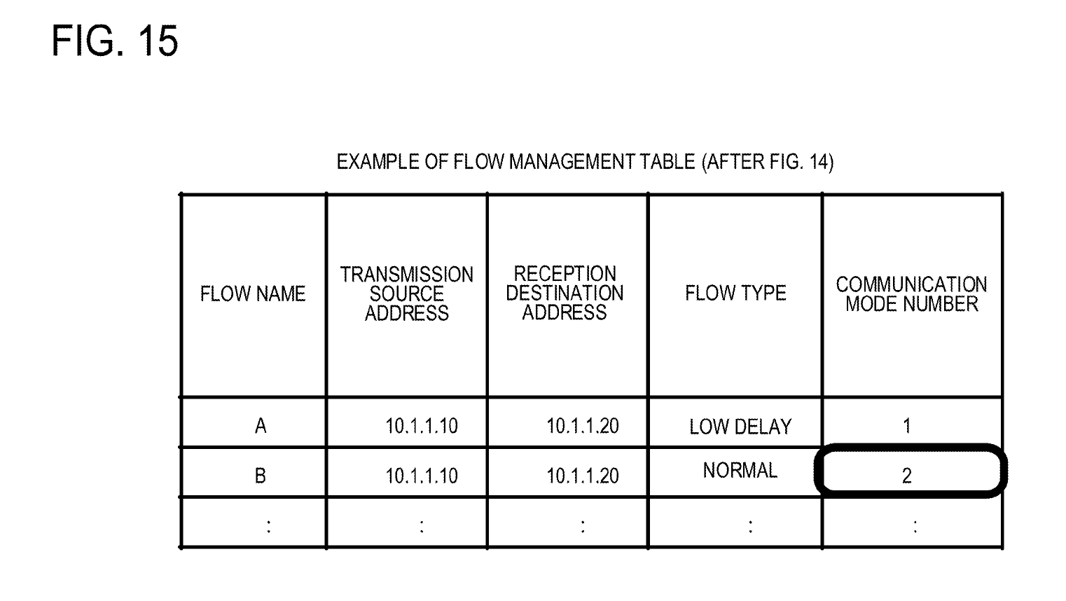

FIG. 15 illustrates an example of the flow management table 19 of the controller 1 after processing illustrated in FIG. 14. When the controller 1 determines that the communication mode of flow B is changed from the communication mode of communication mode number “1” to the communication mode of communication mode number “2”, the controller 1 updates the communication mode number of the entry of flow B in the flow management table 19 to “2” (OP15 in FIG. 11B). Therefore, the communication mode number of the entry of flow B in the flow management table 19 illustrated in FIG. 15 is “2”.

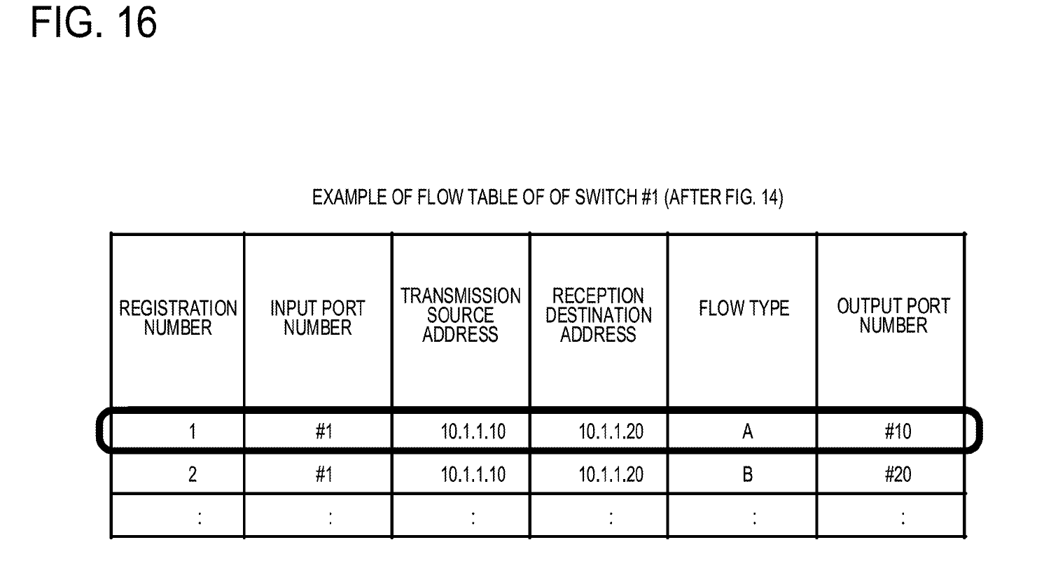

FIG. 16 illustrates an example of the flow table of switch #1 after the processing illustrated in FIG. 14. The flow table of switch #1 is set by the FlowMod so as to transfer the packet of flow B to the controller 1 from the controller 1 using the PacketIn (OP14 in FIG. 11B). Therefore, when the packet of flow B is input from port #1 of switch #1, the entry of registration number “2”, which indicates that the packet is output from port #20 connected to the controller 1, is stored in the flow table of switch #1.

In FIG. 14, although the description of flow A is omitted, the controller 1 may instruct switch #1 to transfer the packet of flow B to the controller 1 using the PacketIn and instruct switch #1 to transfer the packet of flow A to route #1. Therefore, when the packet of flow A is input from port #1 of switch #1, the entry of registration number “1”, which indicates that the packet is output to port #10 connected to route #1, is stored in the flow table of switch #1 illustrated in FIG. 16.

However, it may not be necessary to explicitly instruct the transfer of the packet of flow A to route #1. An entry instructing to transmit the PacketIn for the packet of flow B may be registered in a flow bull of switch #1 with a smaller registration number using a feature of the flow table that the entry having a smaller registration number is preferentially adopted.

In the flow tables of switches #2 to #5 after the processing illustrated in FIG. 14, there is no change from the initial state.

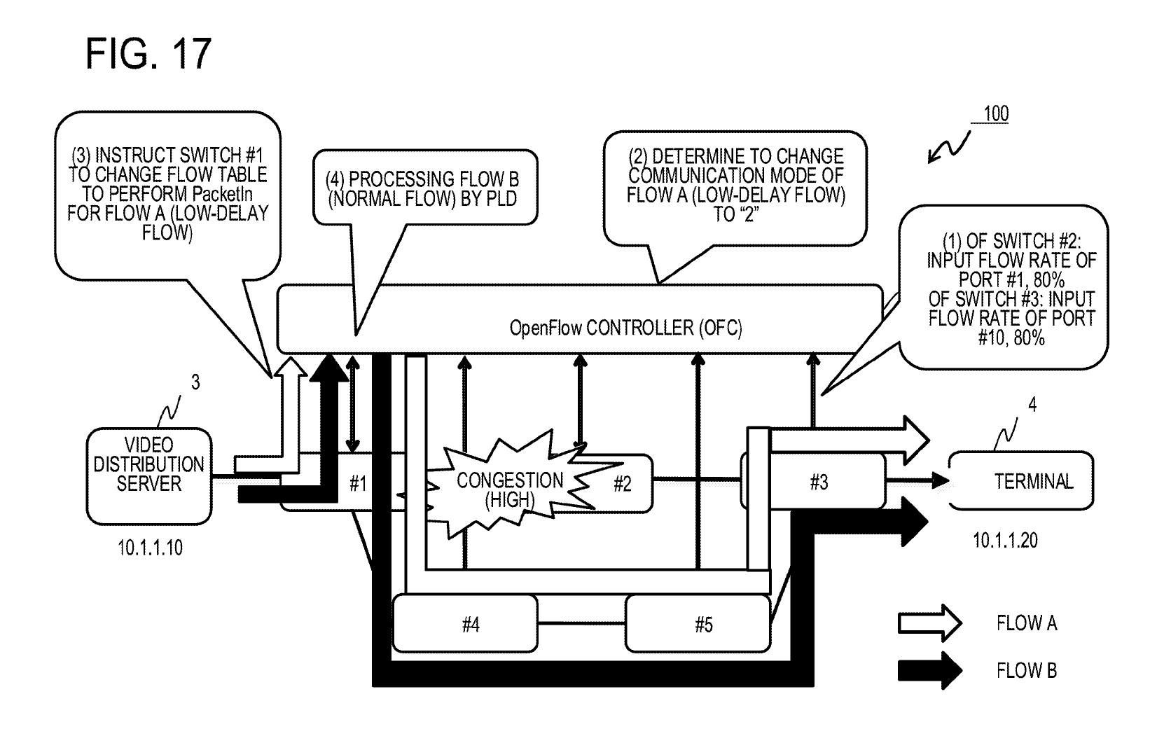

FIG. 17 is a diagram illustrating an example of the routes of flow A and flow B when route #1 further gets congested after the processing illustrated in FIG. 14. (1) The controller 1 receives load information including that the input flow rate of port #1 of switch #2 is 80% from switch #2. The load information from switch #2 indicates that route #1 further gets congested. Further, the controller 1 receives load information including that the output flow rate of port #10 of switch #3 is 80% from switch #3.

(2) Based on the load information management table 16 and the distribution determination table 18, the controller 1 determines to change the communication mode of flow A, which is flow type “low delay”, to the communication mode of communication mode number “2” (OP11: YES in FIG. 11B). That is, the controller 1 determines to cause the PLD transfer processing unit 13 to execute the packet transfer processing for flow A.

(3) The controller 1 sets transferring the packet of flow A to the controller 1 using the PacketIn in the flow table of switch #1 (OP14 in FIB. 11B). Switch #1 is the switch 2 located at the branch point between route #1 and route #2.

As a result, switch #1 transfers both the packet of flow A and the packet of flow B to the controller 1 using the PacketIn.

(4) The controller 1 sets the PLD transfer processing unit 13 so as to transmit the PacketOut designating the port connected to route #2 to switch #1 as the output port of the packet of flow A (OP16 in FIB. 11B). When the packet of flow A is transferred from switch #1 to the controller 1 by using PacketIn, the PLD transfer processing unit 13 of the controller 1 transmits the PacketOut designating the port connected to route #2, for example, as the output port of the packet of flow A to switch #1.

The PacketOut transmitted to switch #1 includes, for example, the packet of flow A transferred to the controller 1 by the PacketIn and the designation of port #5 of switch #1 as the output port.

Upon receiving the PacketOut, switch #1 outputs the packet of flow A included in the PacketOut from port #5 connected to route #2. As a result, the route of flow A is changed from route #1 to route #2.

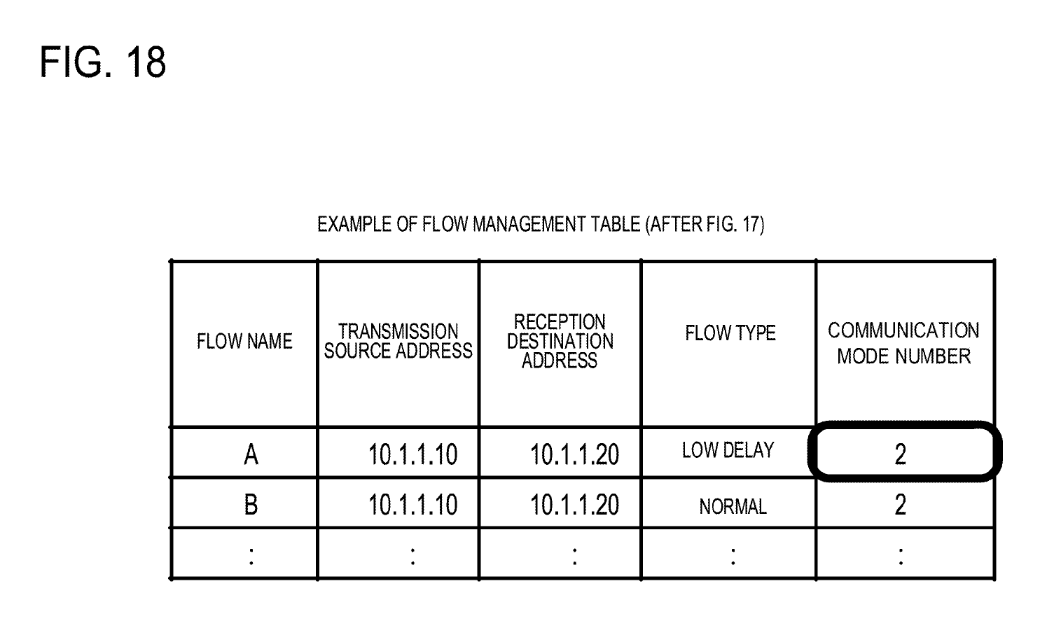

FIG. 18 illustrates an example of the flow management table 19 of the controller 1 after the processing illustrated in FIG. 17. When the controller 1 determines that the communication mode of flow A is changed from the communication mode of communication mode number “1” to the communication mode of communication mode number “2”, the controller 1 updates the communication mode number of the entry of flow A in the flow management table 19 to “2” (OP15 in FIG. 11B). Therefore, the communication mode number of the entry of flow A in the flow management table 19 illustrated in FIG. 18 is “2”.

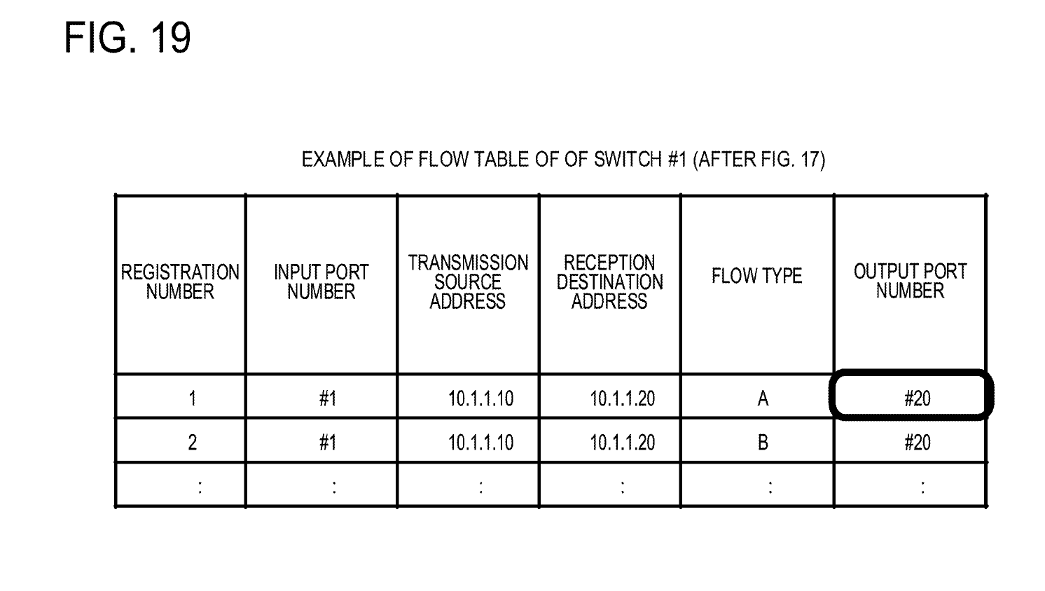

FIG. 19 illustrates an example of the flow table of switch #1 after the processing illustrated in FIG. 17. The flow table of switch #1 is set by the FlowMod so as to transfer the packet of flow A to the controller 1 from the controller 1 using the PacketIn (OP14 in FIG. 11B). Therefore, when the packet of flow A is input from port #1 of switch #1, the entry of registration number “1”, which indicates that the packet is output from port #20 connected to the controller 1, is stored in the flow table of switch #1.

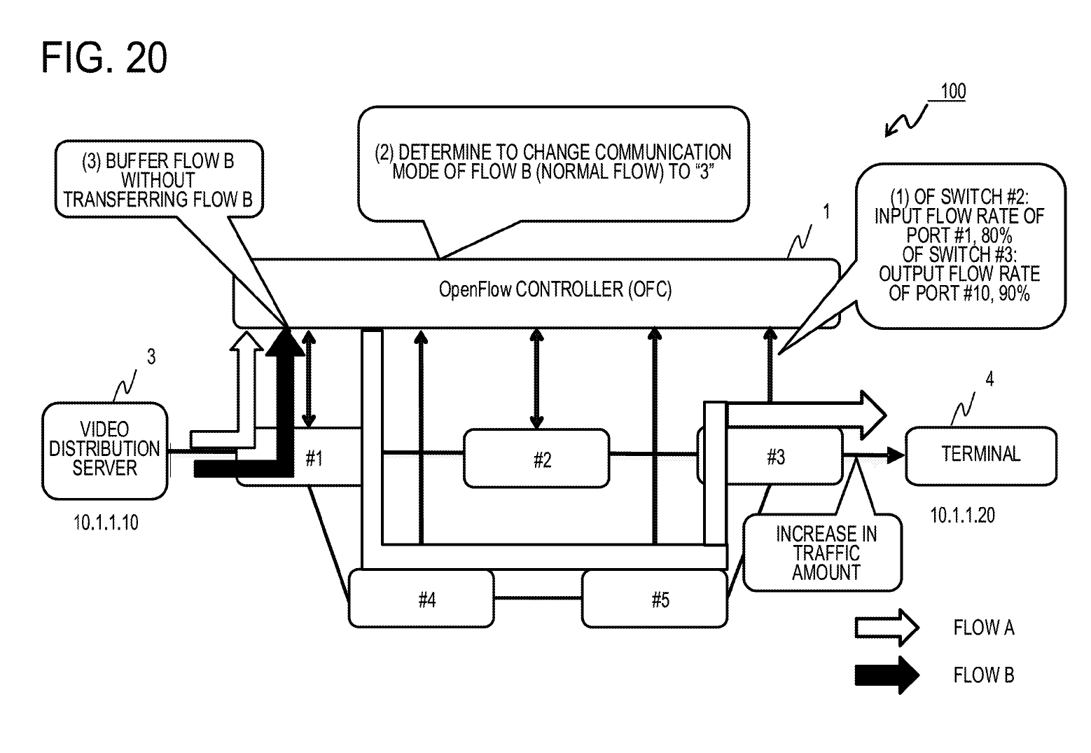

FIG. 20 is a diagram illustrating an example of the routes of flow A and flow B when a traffic amount input into the terminal 4 increases after the processing illustrated in FIG. 17. (1) The controller 1 receives load information including that the input flow rate of port #1 of switch #2 is 80% from switch #2. Further, the controller 1 receives load information including that the output flow rate of port #10 of switch #3 is 90% from switch #3. The load information from switch #3 indicates that the traffic amount input into the terminal 4 increases.

(2) Based on the load information management table 16 and the distribution determination table 18, the controller 1 determines to change the communication mode of flow B, which is flow type “normal”, to the communication mode of communication mode number “3” (OP17: YES in FIG. 11B). That is, the controller 1 determines to change the packet of flow B to be buffered to the packet buffer 14B of the controller 1 without transferring the packet of flow B.

(3) In FIG. 20, it is already set that the packet of flow B is transferred to the controller 1 to the switch #1 using the PacketIn. Further, the controller 1 instructs the CPU transfer processing unit 14 to buffer the packet of flow B (OP20 in FIG. 11B). Therefore, when the packet of flow B is transferred from switch #1 using the PacketIn, the controller 1 buffers the packet of flow B to the packet buffer 14B.

As a result, it is possible to temporarily stop the flow of flow B and reduce the traffic amount flowing into the terminal 4, thereby suppressing an increase in processing load on the terminal 4.

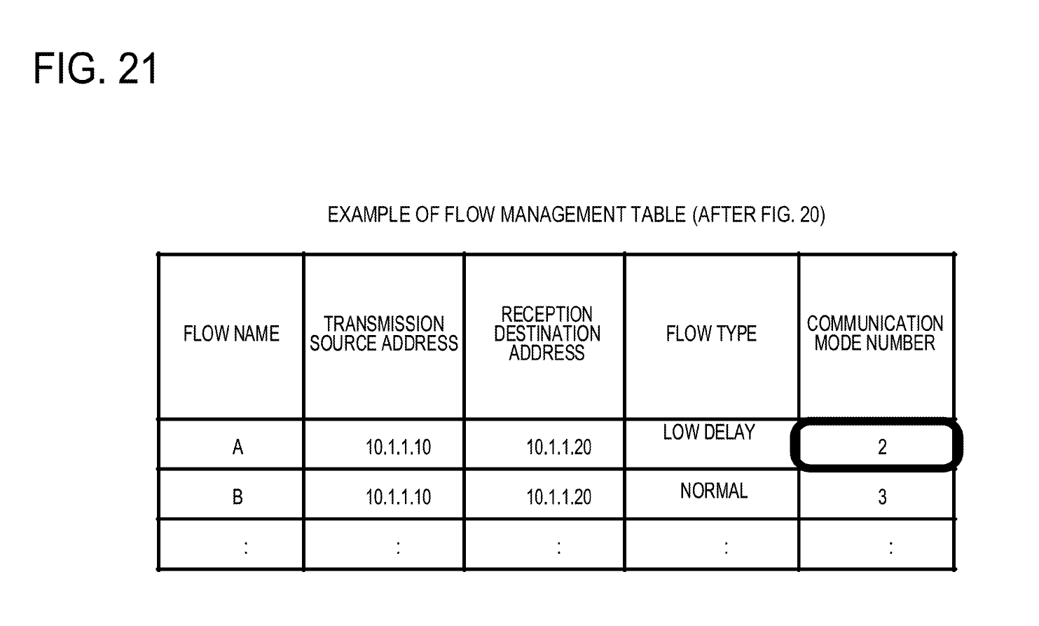

FIG. 21 illustrates an example of the flow management table 19 of the controller 1 after the processing illustrated in FIG. 20. When the controller 1 determines that the communication mode of flow B is changed from the communication mode of communication mode number “2” to the communication mode of communication mode number “3”, the controller 1 updates the communication mode number of the entry of flow A in the flow management table 19 to “3” (OP19 in FIG. 11B). Therefore, the communication mode number of the entry of flow B in the flow management table 19 illustrated in FIG. 21 is “3”. By the processing illustrated in FIG. 20, the flow table of any switch 2 is not changed.

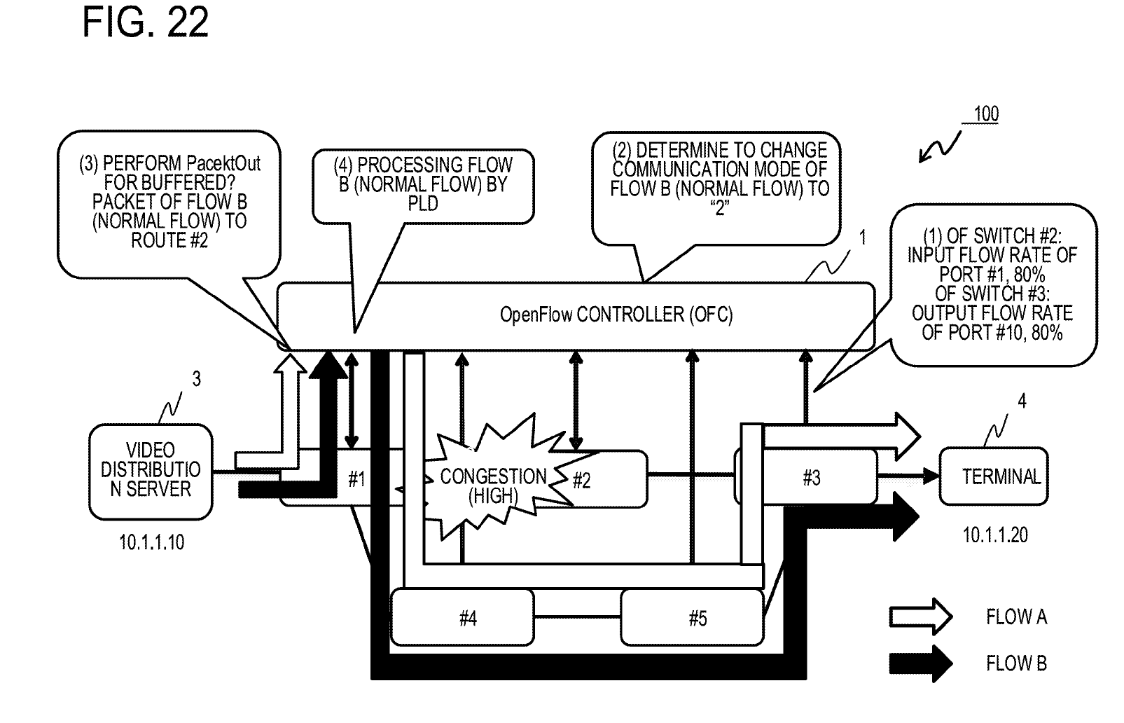

FIG. 22 is a diagram illustrating an example of the routes of flow A and flow B when the traffic amount input into the terminal 4 decreases after the processing illustrated in FIG. 20. (1) The controller 1 receives load information including that the input flow rate of port #1 of switch #2 is 80% from switch #2. Further, the controller 1 receives load information including that the output flow rate of port #10 of switch #3 is 80% from switch #3. The load information from switch #3 indicates that the traffic amount input into the terminal 4 decreases.

(2) Based on the load information management table 16 and the distribution determination table 18, the controller 1 determines to change the communication mode of flow B, which is flow type “normal”, to the communication mode of communication mode number “2” (OP17: YES in FIG. 11B). That is, the controller 1 determines to cause the PLD transfer processing unit 13 to execute the packet transfer processing for flow B.

(3) The controller 1 reads the buffered packet of flow B so as to transmit the PacketOut designating the port connected to route #2 to switch #1 as the output port of the packet of flow B (OP12: YES and OP13 in FIG. 11B).

(4) The controller 1 sets the PLD transfer processing unit 13 so as to transmit the PacketOut designating the port connected to route #2 to switch #1 as the output port of the packet of flow B (OP16 in FIG. 11B). Thereafter, when the packet of flow B is transferred from switch #1 to the controller 1 by using the PacketIn, the PLD transfer processing unit 13 of the controller 1 transmits the PacketOut designating the port connected to route #2 to switch #1 as the output port of the packet of flow B. As a result, flow B passes through route #2 again.

Thereafter, for example, when the congestion of route #1 is resolved, it is determined that the communication modes of flow A and flow B are changed to the communication mode of communication mode number “1” in which transfer is performed by route #1 according to the load information from the switch 2.

### Operational Effect of First Embodiment

In the first embodiment, when the priority route becomes congested, the controller 1 performs control to change the route of the flow having the low priority to the detour route. In the first embodiment, the packet of the flow as the target of the route change is transferred to the controller 1 by the PacketIn by the switch 2 and the controller 1 designates the output port of the packet in the switch 2 by the PacketOut so as to perform the route change. In the first embodiment, the packet transfer processing related to the PacketIn and the PacketOut is executed by the PLD 103 of the controller 1 having a high processing speed for the flow as the target of the route change.

Therefore, according to the first embodiment, the processing load on the CPU 101 of the controller 1 may be reduced. Therefore, it is possible to suppress an influence such as, for example, an increase in processing delay due to the packet transfer processing for the flow as the target of the route change or the like on the processing of another flow executed by the CPU 101 of the controller 1.

In addition, the processing by the PLD 103 is hardware processing and is faster in the processing speed than the processing by the CPU 101 which is software processing. Therefore, even when the flow is transferred via the controller 1 to the detour route whose transfer delay is larger than the priority route, the increase in the transfer delay of the flow may be suppressed.

Further, according to the first embodiment, for example, in the distribution determination table 18, the packet distribution rule and the communication mode are set for each flow type. Therefore, according to the type of flow, it is possible to perform the route change based on the congestion degree of the priority route and changeover of a distribution destination of packet processing, so that fine and detailed control may be performed.

Further, according to the first embodiment, when a traffic inflow amount to the terminal 4 as the transmission destination exceeds a threshold value, the packet of the flow having the low priority is buffered to the controller 1. As a result, it is possible to reduce the traffic of the flow having the low priority and to suppress the increase in the processing load of the terminal 4. Further, therefore, it is possible to increase a convergence speed of flooding of traffic which flows into the terminal 4.

Further, in the first embodiment, it is possible to suppress the increase in the transfer delay of the flow having the high priority by preferentially transferring the high priority flow to the priority route.

### Others

In the first embodiment, it has been described on the premise that the PacketIn includes a target packet body. However, the PacketIn may be used without including the target packet body. The technique described in the first embodiment may also be applied to a case where the PacketIn not including a packet body is used.

When the PacketIn does not include the target packet body, for example, the PacketIn itself is buffered to the packet buffer 14B in the communication mode of communication mode number “3”.

Further, although the first embodiment has been described on the premise of the OpenFlow controller and the OpenFlow switch, the application of the technique described in the first embodiment is not limited to the system that implements the OpenFlow. For example, the technique described in the first embodiment may be applied to a system in which route control of a plurality of switches is performed by one or a plurality of controllers.

### Processor

The CPU is also called a microprocessor (MPU) or a processor. The CPU is not limited to a single processor, but may be a multiprocessor configuration. Further, the single CPU connected by a single socket may have a multi-core configuration. Processing of at least a part of each of the above units may be performed by a processor other than the CPU, for example, a dedicated processor such as a DSP or a network processing unit (NPU).

### Recording Medium

A program for implementing any one of the functions described above in a computer or other machine and apparatus (hereinafter, referred to as a computer or the like) may be recorded in a recording medium readable by the computer or the like. The computer or the like reads and executes the program of the recording medium, so that the function may be provided.

Herein, the recording medium readable by the computer or the like refers to a non-temporary recording medium that accumulates information such as the data and the program by an electrical, magnetic, optical, mechanical, or chemical action and is readable by the computer or the like. Among the recording media, the recording media that may be detached from the computer or the like include memory cards including, for example, a flexible disk, a magneto-optical disk, a CD-ROM, a CD-R/W, a DVD, a Blu-ray disk, a DAT, an 8 mm tape, a flash memory, and the like. Further, the recording media fixed to the computer or the like include a hard disk, a read only memory (ROM), and the like. In addition, a solid state drive (SSD) may be used as both the recording media which may be detached from the computer or the like and the recording media fixed to the computer or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication control apparatus comprising:
a memory; and
a processor coupled to the memory and the processor configured to:
receive load information of each of a plurality of switches;
when a first condition of a plurality of conditions related to a route is satisfied with the load information,
receive a request for route information of a packet transmitted from a first switch of the plurality of switches; and
inform the first switch of an instruction for outputting the packet to the route on which the first condition is satisfied.

2. The communication control apparatus according to claim 1,
wherein the processor is configured to:
when the first condition is satisfied with the load information,
transmits a transmission instruction of the request for route information of the packet to the first switch that is arranged at a branch point of a first route which is a route of a flow including the packet and a second route used as a detour of the first route; and
inform the first switch of an instruction for outputting the packet to a port of the first switch coupled to the second route, according to the request for route information of the packet from the first switch.

3. The communication control apparatus according to claim 1,
wherein the memory is configured to store information of a plurality of first conditions corresponding to each of types of a plurality of flows between the plurality of switches and information of the route on which the first condition is satisfied, and
wherein the processor is configured to inform the first switch of an instruction for outputting, to the route on which the first condition is satisfied, the packet included in the flow on which the first condition is satisfied, based on the information stored in the memory.

4. The communication control apparatus according to claim 2,
wherein the first condition is related to traffic congestion of the first route, and
wherein the processor is configured to store the request for route information of the packet to the memory when a second condition of the plurality of conditions is satisfied with the load information, the second condition relating to processing load of a destination of the first route.

5. The communication control apparatus according to claim 4,
wherein the memory is configured to store
information of a plurality of first conditions corresponding to each of types of a plurality of flows between the plurality of switches and information of the route on which the first condition is satisfied, and
the second condition for each of flows having lower priority than a predetermined level of the plurality of flows,
wherein the processor is configured to
inform the first switch of an instruction for outputting, to the route on which the first condition is satisfied, the packet included in the flow on which the first condition is satisfied, and
store, to the memory, the request for route information of the packet included in the flow on which the second condition is satisfies, based on the information stored in the memory.

6. A communication control method comprising:
receiving load information of each of a plurality of switches;
when a first condition of a plurality of conditions related to a route is satisfied with the load information,
receiving a request for route information of a packet transmitted from a first switch of the plurality of switches; and
informing the first switch of an instruction for outputting the packet to the route on which the first condition is satisfied, by a processor.

7. A computer-readable non-transitory recording medium storing a program that causes a computer to execute a procedure, the procedure comprising:
receiving load information of each of a plurality of switches;
when a first condition of a plurality of conditions related to a route is satisfied with the load information,
receiving a request for route information of a packet transmitted from a first switch of the plurality of switches; and
informing the first switch of an instruction for outputting the packet to the route on which the first condition is satisfied.
